(19) United States
(12) Patent Application Publication
(10) Pub. No.: US 2026/0064022 A1
(43) Pub. Date: Mar. 5, 2026

(54) ELECTROPHOTOGRAPHIC PHOTORECEPTOR, PROCESS CARTRIDGE, AND IMAGE FORMING APPARATUS

(71) Applicant: KYOCERA DOCUMENT SOLUTIONS INC., OSAKA (JP)

(72) Inventors: KAZUTAKA SUGIMOTO, OSAKA (JP); DAISUKE KUBOSHIMA, OSAKA (JP); KATSUNORI TERAOKA, OSAKA (JP); HIROKI OTSUKA, OSAKA (JP); RYOTA MORIKAWA, OSAKA (JP)

(21) Appl. No.: 18/825,189

(22) Filed: Sep. 5, 2024

(51) Int. Cl. G03G 5/147; G03G 15/02; G03G 21/18

(52) U.S. Cl. CPC G03G 5/14726; G03G 5/14704; G03G 5/14795; G03G 15/0216; G03G 21/1814

(57) ABSTRACT

An electrophotographic photoreceptor includes: a conductive substrate; a photosensitive layer; and a protective layer. The photosensitive layer includes a charge generating agent and a hole transporting agent. The protective layer is a top surface layer of the electrophotographic photoreceptor. The protective layer includes a tin oxide particle and an alumina particle. A content of the tin oxide particle is greater than a content of the alumina particle. The tin oxide particle is favorably a phosphorus-doped tin oxide particle or an antimony-doped tin oxide particle.

### FIELD OF THE DISCLOSURE

The present disclosure relates to an electrophotographic photoreceptor, a process cartridge, and an image forming apparatus.

### BACKGROUND OF THE DISCLOSURE

When an image forming apparatus including an electrophotographic photoreceptor is used to form images repeatedly, the electrophotographic photoreceptor gradually wears out in some cases. In order to suppress wear and extend the lifetime of the electrophotographic photoreceptor, a hard protective layer is provided on the surface of the electrophotographic photoreceptor in some cases. For example, the protective layer included in the electrophotographic photoreceptor disclosed in Japanese Patent Application Laid-open No. 2010-14948 includes a composition. This composition is obtained by reacting a silica fine particle having at least a polymerizable unsaturated group with an organic compound having a reactive group capable of forming a chemical bond with the polymerizable unsaturated group.

### SUMMARY OF THE DISCLOSURE

However, in order to produce the electrophotographic photoreceptor disclosed in Japanese Patent Application Laid-open No. 2010-14948, it is necessary to react a silica fine particle having a polymerizable unsaturated group with an organic compound having a reactive group capable of forming a chemical bond with the polymerizable unsaturated group. For this reason, the process of producing the electrophotographic photoreceptor disclosed in Japanese Patent Application Laid-open No. 2010-14948 is complicated. Further, the present inventors' study has revealed that the electrophotographic photoreceptor disclosed in Japanese Patent Application Laid-open No. 2010-14948 has room for improvement in terms of sensitivity characteristics, charging characteristics, wear resistance, and suppression of the occurrence of image deletion of a formed image.

In view of the circumstances as described above, it is desirable to provide an electrophotographic photoreceptor, a process cartridge, and an image forming apparatus that can be easily produced, have excellent sensitivity characteristics, charging characteristics, and wear resistance, and are capable of suppressing the occurrence of image deletion of a formed image.

### Solution to Problem

According to an embodiment of the present invention, there is provided an electrophotographic photoreceptor, including: a conductive substrate; a photosensitive layer; and a protective layer. The photosensitive layer includes a charge generating agent and a hole transporting agent. The protective layer is a top surface layer of the electrophotographic photoreceptor. The protective layer includes a tin oxide particle and an alumina particle. A content of the tin oxide particle is greater than a content of the alumina particle.

According to an embodiment of the present invention, there is provided a process cartridge, including: at least one selected from the group consisting of a charging device, an exposure device, a development device, a transfer device, a cleaning member, a rubbing roller, and a static elimination device; and the above electrophotographic photoreceptor.

According to an embodiment of the present invention, there is provided an image forming apparatus, including: an image carrier; a charging device that charges a surface of the image carrier; an exposure device that exposes the charged surface of the image carrier to form an electrostatic latent image on the surface of the image carrier; a development device that supplies a toner to the surface of the image carrier to develop the electrostatic latent image as a toner image; and a transfer device that transfers the toner image from the image carrier onto a to-be-transferred body. The image carrier is the above electrophotographic photoreceptor.

The electrophotographic photoreceptor, process cartridge, and image forming apparatus according to embodiments of the present disclosure can be easily produced, have excellent sensitivity characteristics, charging characteristics, and wear resistance, and are capable of suppressing the occurrence of image deletion of a formed image.

These and other objects, features and advantages of the present disclosure will become more apparent in light of the following detailed description of best mode embodiments thereof, as illustrated in the accompanying drawings.

### BRIEF DESCRIPTION OF THE DRAWINGS

FIG. 1 is a partial cross-sectional view of a single-layer electrophotographic photoreceptor that is an example of electrophotographic photoreceptor according to a first embodiment of the present disclosure;

FIG. 2 is a partial cross-sectional view of a single-layer electrophotographic photoreceptor that is an example of the electrophotographic photoreceptor according to the first embodiment of the present disclosure;

FIG. 3 is a partial cross-sectional view of a stacked electrophotographic photoreceptor that is an example of the electrophotographic photoreceptor according to the first embodiment of the present disclosure;

FIG. 4 is a partial cross-sectional view of a stacked electrophotographic photoreceptor that is an example of the electrophotographic photoreceptor according to the first embodiment of the present disclosure;

FIG. 5 is a partial cross-sectional view of a stacked electrophotographic photoreceptor that is an example of the electrophotographic photoreceptor according to the first embodiment of the present disclosure;

FIG. 6 is a diagram showing an image forming apparatus according to a second embodiment of the present disclosure; and

FIG. 7 is a diagram showing an example of a configuration of a development device shown in FIG. 6.

### DETAILED DESCRIPTION OF THE EXEMPLARY EMBODIMENTS

Embodiments of the present disclosure will be described below in detail. However, the present disclosure is not limited to the following embodiments and can be appropriately modified within the spirit of the present disclosure and carried out.

First, terms used in the present specification will be described. Acrylic and methacrylic are collectively referred to as “(meth)acrylic” in some cases. Unless otherwise specified, the hydroxyl value is a value measured in accordance with “JIS (Japanese Industrial Standard) K0070-1992”. Unless otherwise specified, the number average primary particle size is a number average value of an equivalent circle diameter (Heywood diameter: diameter of a circle having the same area as the projected area of a primary particle) of a primary particle measured using a scanning electron microscope. The number average primary particle size is, for example, a number average value of equivalent circle diameters of 100 primary particles. Unless otherwise specified, the BET specific surface area is a value measured by a BET method using nitrogen adsorption in accordance with “JIS (Japanese Industrial Standard) Z8830:2001 Determination of the specific surface area of powders (solids) by gas adsorption-BET method”. Unless otherwise specified, the number average molecular weight (Mn) is a value measured using gel permeation chromatography. The term “-based” is added after the compound name to collectively refer to the compound and derivatives thereof in some cases. Further, in the case of adding the term “-based” after a compound to refer to a polymer name, it means that the repeating unit of the polymer is derived from the compound or a derivative thereof. Further, a “general formula” and a “chemical formula” are collectively referred to as a “formula”. The phrase “each independently” in the description of the formula means that they may indicate the same group or different groups. The phrase “at least one type of A, B, and C” means “at least one selected from the group consisting of A, B, and C”. Note that A, B, and C are merely examples and can be replaced with other terms. Unless otherwise specified, the components described in the present specification may each be used alone, or two or more of them may be used in combination. The terms used in the present specification have been described above.

### First Embodiment: Electrophotographic Photoreceptor

A first embodiment of the present disclosure relates to an electrophotographic photoreceptor (hereinafter, referred to as a photoreceptor in some cases). The photoreceptor according to the first embodiment includes a conductive substrate, a photosensitive layer, and a protective layer. The photosensitive layer includes a charge generating agent and a hole transporting agent. The protective layer is the top surface layer of the photoreceptor. The protective layer includes a tin oxide particle and an alumina particle. The content of the tin oxide particle is greater than the content of the alumina particle.

By having the above configuration, the photoreceptor according to the first embodiment has excellent sensitivity characteristics, charging characteristics, and wear resistance and is capable of suppressing the occurrence of image deletion of a formed image. The reasons for this are presumed to be as follows.

The photoreceptor according to the first embodiment includes a protective layer on its top surface. Since the protective layer has a hardness higher than that of the photosensitive layer, the wear resistance of the photoreceptor is improved.

However, since drift of charges easily occurs in the protective layer, the photoreceptor including the protective layer tends to have image deletion in a formed image. The drift of charges is a phenomenon in which charges are transported not in the thickness direction of the protective layer but in the surface direction and the position of the charge reaching the surface of the protective layer shifts during exposure of image formation. Here, in the first embodiment, the protective layer include a tin oxide particle. Since the tin oxide particle has low electric resistance, charges move smoothly in the protective layer when the protective layer includes the tin oxide particle. The charges smoothly moving in the protective layer suppress the drift of charges in the protective layer and make it possible to prevent image deletion from occurring in a formed image. Further, the charges smoothly moving in the protective layer also improve sensitivity characteristics of the photoreceptor.

However, since the tin oxide particle has low electric resistance, the photoreceptor that includes the protective layer including the tin oxide particle is not sufficiently charged in some cases because charges easily escape during charging. Here, in the first embodiment, the protective layer includes an alumina particle in addition to the tin oxide particle. Since the electric resistance of the alumina particle is higher than the electric resistance of the tin oxide particle, it is possible to sufficiently charge the photoreceptor and improve charging characteristics of the photoreceptor when the protective layer includes the alumina particle.

Further, in the case where the content of the tin oxide particle having low electric resistance is equal to or lower than the content of the alumina particle having high electric resistance, charges do not move smoothly in the protective layer in some cases. Here, in the first embodiment, the content of the tin oxide particle is greater than the content of the alumina particle. For this reason, charges move smoothly in the protective layer, which improves sensitivity characteristics of the photoreceptor.

Further, the tin oxide particle and the alumina particle each have a relatively high hardness. When the protective layer includes the tin oxide particle and the alumina particle, wear resistance of the photoreceptor is further improved.

The reason why the photoreceptor according to the first embodiment has excellent sensitivity characteristics, charging characteristics, and wear resistance and is capable of suppressing the occurrence of image deletion of a formed image has been described above. The photoreceptor will be further described below.

The photoreceptor is, for example, a single-layer electrophotographic photoreceptor (hereinafter, referred to as a single-layer photoreceptor in some cases) or a stacked electrophotographic photoreceptor (hereinafter, referred to as a stacked photoreceptor in some cases).

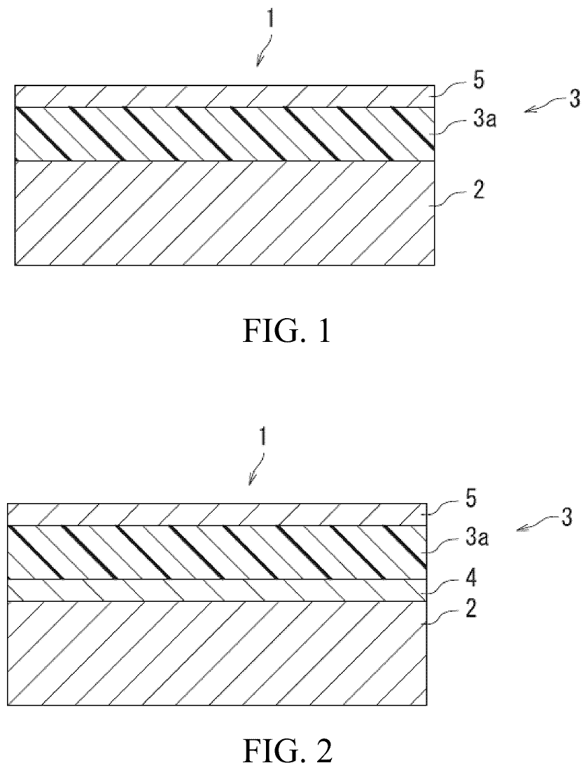

A structure of a single-layer photoreceptor 1 that is an example of a photoreceptor will be described below with reference to FIG. 1 to FIG. 2. FIG. 1 to FIG. 2 are each a partial cross-sectional view of the single-layer photoreceptor 1. As shown in FIG. 1, the single-layer photoreceptor 1 includes, for example, a conductive substrate 2, a photosensitive layer 3, and a protective layer 5. The photosensitive layer 3 is a single layer. Hereafter, the “photosensitive layer that is a single layer” will be referred to as a “single-layer photosensitive layer” in some cases. In the example shown in FIG. 1, a single-layer photosensitive layer 3a is provided on the conductive substrate 2 and the protective layer 5 is provided on the single-layer photosensitive layer 3a. The single-layer photosensitive layer 3a is provided directly on the conductive substrate 2. The protective layer 5 is the top surface layer of the single-layer photoreceptor 1.

As shown in FIG. 2, the single-layer photoreceptor 1 may further include an intermediate layer 4 (undercoat layer), in addition to the conductive substrate 2, the single-layer photosensitive layer 3a, and the protective layer 5. In the example shown in FIG. 2, the intermediate layer 4 is provided on the conductive substrate 2, the single-layer photosensitive layer 3a is provided on the intermediate layer 4, and the protective layer 5 is provided on the single-layer photosensitive layer 3a. The single-layer photosensitive layer 3a is provided above the conductive substrate 2 via the intermediate layer 4.

The thickness of the single-layer photosensitive layer 3a is not particularly limited, but is favorably 5 μm or more and 100 μm or less, more favorably 10 μm or more and 50 μm or less.

The thickness of the protective layer 5 is not particularly limited, but is favorably 1 μm or more and 30 μm or less, more favorably 1 μm or more and 4 μm or less, and particularly favorably 2 μm or more and 4 μm or less. When the thickness of the protective layer 5 is 1 μm or more, sensitivity characteristics of the photoreceptor are improved. When the thickness of the protective layer 5 is 30 μm or less, the wear resistance of the photoreceptor is improved. In the examples shown in FIG. 1 and FIG. 2, the protective layer 5 is one layer. However, the protective layer 5 may include a plurality of layers. In the case where the protective layer 5 includes a plurality of layers, at least the top surface layer, of the plurality of layers, includes a photocurable resin. The structure of the single-layer photoreceptor 1 that is an example of a photoreceptor has been described above with reference to FIG. 1 and FIG. 2.

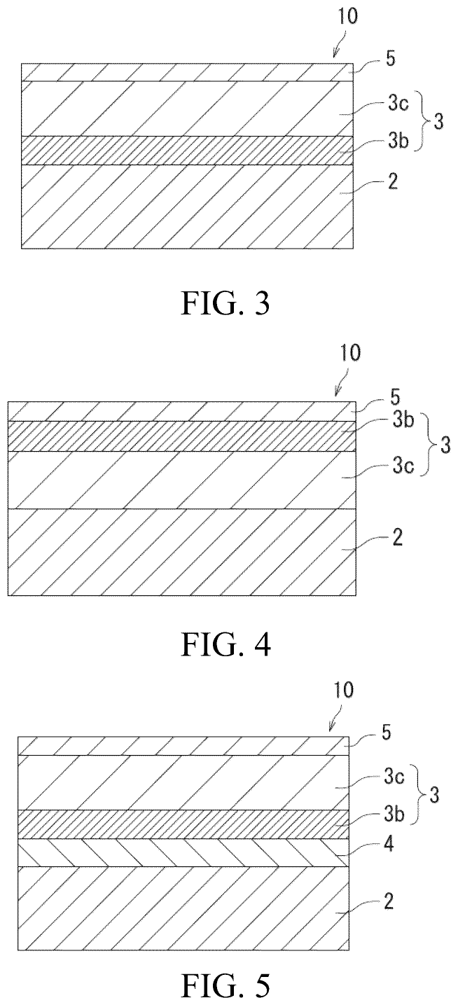

A structure of a stacked photoreceptor 10 that is an example of a photoreceptor will be described below with reference to FIG. 3 to FIG. 5. FIG. 3 to FIG. 5 are each a partial cross-sectional view of the stacked photoreceptor 10. As shown in FIG. 3, the stacked photoreceptor 10 includes, for example, the conductive substrate 2, the photosensitive layer 3, and the protective layer 5. The photosensitive layer 3 includes a charge generating layer 3b and a charge transporting layer 3c. In the example shown in FIG. 3, the charge generating layer 3b is provided on the conductive substrate 2, the charge transporting layer 3c is provided on the charge generating layer 3b, and the protective layer 5 is provided on the charge transporting layer 3c. However, as shown in FIG. 4, in the stacked photoreceptor 10, the charge transporting layer 3c may be provided on the conductive substrate 2, the charge generating layer 3b may be provided on the charge transporting layer 3c, and the protective layer 5 may be provided on the charge generating layer 3b. In the examples shown in FIG. 3 and FIG. 4, the photosensitive layer 3 is provided directly on the conductive substrate 2. The protective layer 5 is the top surface layer of the stacked photoreceptor 10.

As shown in FIG. 5, the stacked photoreceptor 10 may further include the intermediate layer 4 (undercoat layer), in addition to the conductive substrate 2, the photosensitive layer 3, and the protective layer 5. In the example shown in FIG. 5, the intermediate layer 4 is provided on the conductive substrate 2, the charge generating layer 3b is provided on the intermediate layer 4, the charge transporting layer 3c is provided on the charge generating layer 3b, and the protective layer 5 is provided on the charge transporting layer 3c. The photosensitive layer 3 (e.g., the charge generating layer 3b) is provided above the conductive substrate 2 via the intermediate layer 4.

The thickness of the charge generating layer 3b is not particularly limited, but is favorably 0.01 μm or more and 5 μm or less, more favorably 0.1 μm or more and 3 μm or less. In the examples shown in FIG. 3 to FIG. 5, the charge generating layer 3b is one layer. However, the charge generating layer 3b may include a plurality of layers.

The thickness of the charge transporting layer 3c is not particularly limited, but is favorably 2 μm or more and 100 μm or less, more favorably 5 μm or more and 50 μm or less. In the examples shown in FIG. 3 to FIG. 5, the charge transporting layer 3c is one layer. However, the charge transporting layer 3c may include a plurality of layers.

Since the protective layer 5 included in the stacked photoreceptor 10 is similar to the protective layer 5 included in the single-layer photoreceptor 1, description thereof is omitted. The structure of the stacked photoreceptor 10 that is an example of a photoreceptor has been described above with reference to FIG. 3 to FIG. 5.

### <Protective Layer>

The protective layer includes a tin oxide particle, an alumina particle, and a resin. Hereinafter, the “resin included in the protective layer” will be referred to as a “protective layer resin” in some cases. The protective layer may further include, as necessary, one or both of a polymerization initiator and an additive.

### (Tin Oxide Particle and Alumina Particle)

The tin oxide particle may be undoped. However, the tin oxide particle is favorably doped. When the tin oxide particle is doped, the electric resistance of the tin oxide particle is further reduced, and occurrence of image deletion of a formed image can be further suppressed. Further, sensitivity characteristics of the photoreceptor can also be further improved. As the doped tin oxide particle, a phosphorus-doped tin oxide particle or an antimony-doped tin oxide particle is favorable.

As described above, the electric resistance of the alumina particle is higher than the electric resistance of the tin oxide particle. In other words, the volume resistivity of the alumina particle is higher than the volume resistivity of the tin oxide particle.

As described above, the content of the tin oxide particle is greater than the content of the alumina particle. In order to further improve charging characteristics of the photoreceptor, a ratio M1/M2 of the content of M1 of the tin oxide particle to the content of M2 of the alumina particle is favorably 1.1 or more and 15.0 or less, more favorably 1.5 or more and 14.0 or less, and still more favorably 6.0 or more and 13.0 or less.

The BET specific surface area of the tin oxide particle and the alumina particle is favorably 30 m²/g or more and 200 m²/g or less, more favorably 45 m²/g or more and 150 m²/g or less, and still more favorably 70 m²/g or more and 130 m²/g or less.

The number average primary particle size of the tin oxide particle and the alumina particle is favorably 5 nm or more and 500 nm or less, more favorably 30 nm or more and 300 nm or less, and still more favorably 100 nm or more and 200 nm or less.

The tin oxide particle and the alumina particle may have a polymerizable functional group capable of reacting with a photocurable resin. However, the tin oxide particle and the alumina particle do not necessarily need to have a polymerizable functional group capable of reacting with a photocurable resin.

In order to further suppress occurrence of image deletion of a formed image, the content ratio of the tin oxide particle and the alumina particle is favorably 20.0 parts by mass or less, more favorably 13.0 mass % or less, with respect to the mass of the protective layer. In order to provide excellent sensitivity characteristics, charging characteristics, and wear resistance and suppress the occurrence of image deletion of a formed image, the total content ratio of the tin oxide particle and the alumina particle is favorably 0.1 parts by mass or more, more favorably 1.0 parts by mass or more, with respect to the mass of the protective layer.

The content ratio of the tin oxide particle is favorably 1 mass % or more and 15 mass % or less, more favorably 5 mass % or more and 10 mass % or less, with respect to the mass of the protective layer. In order to further improve charging characteristics of the photoreceptor, the content of the tin oxide particle is favorably 15 parts by mass or less with respect to 100 parts by mass of the protective layer excluding both the tin oxide particle and the alumina particle. In order to further improve sensitivity characteristics of the photoreceptor and further suppress the occurrence of image deletion in a formed image, the content of the tin oxide particle is favorably 2 parts by mass or more with respect to 100 parts by mass of the protective layer excluding both the tin oxide particle and the alumina particle.

The content ratio of the alumina particle is favorably 1 mass % or more and less than 5 mass % with respect to the mass of the protective layer. In order to further improve charging characteristics of the photoreceptor, the content of the alumina particle is favorably 1 part by mass or more with respect to 100 parts by mass of the protective layer excluding both the tin oxide particle and the alumina particle. In order to further improve sensitivity characteristics of the photoreceptor and further suppress the occurrence of image deletion in a formed image, the content of the alumina particle is favorably 8 parts by mass or less with respect to 100 parts by mass of the protective layer excluding both the tin oxide particle and the alumina particle.

### (Protective Layer Resin)

Examples of the protective layer resin include a thermosetting resin and a photocurable resin. As the protective layer resin, a photocurable resin is favorable. Examples of the photocurable resin include a (meth)acrylic resin and an epoxy resin. As the photocurable resin, a (meth)acrylic resin is favorable because the photocuring reaction stops when irradiation of ultraviolet rays is stopped, and the progress of the photocuring reaction can be easily controlled.

The photocurable resin favorably includes a repeating unit derived from a compound having one polymerizable functional group and a repeating unit derived from a compound having two or more polymerizable functional groups. Hereinafter, the “repeating unit derived from a compound having one polymerizable functional group” will be referred to as a “monofunctional group unit” and the “compound having one polymerizable functional group” will be referred to as a “monofunctional group monomer” in some cases. Further, the “repeating unit derived from a compound having two or more polymerizable functional groups” will be referred to as a “multifunctional group unit” and the “compound having two or more polymerizable functional groups” will be referred to as a “multifunctional group monomer” in some cases.

When the photocurable resin includes the monofunctional group unit and the multifunctional group unit, the following advantages can be obtained. That is, in a protective layer forming step in the production of a photoreceptor, the monofunctional group monomer for forming a monofunctional group unit enters the gap of the multifunctional group monomer for forming a multifunctional group unit, and a photocurable resin in which the multifunctional group unit and the monofunctional group unit are densely arranged is formed. Further, since the multifunctional group monomer has two or more polymerizable functional groups, a photocuring reaction in which a polymerizable functional group reacts suitably progresses in the protective layer forming step in the production of a photoreceptor. As a result, it is possible to sufficiently increase not only the hardness of the inside of the protective layer but also the hardness of the vicinity of the surface of the protective layer that is easily affected by radicals caused by oxygen in the atmosphere.

Examples of the polymerizable functional group of the monofunctional group unit and the multifunctional group unit include a vinyl group and an epoxy group. In the case where the photocurable resin is a (meth)acrylic resin, the (meth)acrylic resin has a vinyl group as a polymerizable functional group. In the case where the photocurable resin has an epoxy resin, the epoxy resin has an epoxy group as a polymerizable functional group.

The photocurable resin may include one type of monofunctional group unit or two or more types (e.g., 2 types) of monofunctional group unit. Further, the photocurable resin may include one type of multifunctional group unit or two or more types (e.g., 2 types) of multifunctional group units.

The monofunctional group unit of the photocurable resin will be described below. The monofunctional group unit of the photocurable resin favorably further includes a water-repellent group in addition to the one polymerizable functional group. When the monofunctional group unit of the photocurable resin includes a water-repellent group, the water repellency of the protective layer including a photocurable resin increases, which makes it difficult for an aqueous substance to adhered to the surface of the protective layer (corresponding to the top surface of the photoreceptor). The aqueous substance is, for example, moisture in the atmosphere and a reaction product of a radial generated during the curing reaction of the photocurable resin and a nitrogen oxide (NOx) or ozone in the atmosphere. Since aqueous substances are difficult to adhere to the protective layer, a sharp electrostatic latent image can be formed on the surface of the photoreceptor and occurrence of image deletion of a formed image can be further suppressed.

Examples of the water-repellent group include a group containing a halogen atom, a long-chain alkyl group, and a group having a siloxane bond.

Examples of the group containing a halogen atom, which is an example of a water-repellent group, include a fluoro group, a chloro group, a bromo group, an iodo group, a trichloromethyl group, and a group represented by the formula (b1). In order to suitably cure the protective layer and improve the wear resistance of the photoreceptor, the group represented by the formula (b1) is favorable as the group containing a halogen atom.

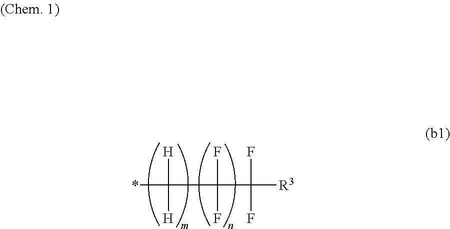

In the formula (b1), m represents 0 or 1. n represents an integer of 1 or more and 3 or less. R³ represents a hydrogen atom or a fluorine atom. * represents atomic bonding. When n represents 1 or more, sufficient water repellency is imparted to the monofunctional group unit, and occurrence of image deletion of a formed image can be further suppressed. When n represents 3 or less, it is possible to sufficiently cure the photocurable resin and further improve the wear resistance of the photoreceptor in the protective layer forming step in the production of a photoreceptor. In the formula (b1), m favorably represents 1. n favorably represents 1 or 3. R³ favorably represents a hydrogen atom.

In order to suppress occurrence of image deletion of a formed image, the long-chain alkyl group that is an example of a water-repellent group favorably represents an alkyl group having 10 or more and 18 or less carbon atoms, more favorably an alkyl group having 15 or more and 18 or less carbon atoms, and still more favorably an alkyl group having 18 carbon atoms.

The siloxane bond of the group having a siloxane bond that is an example of a water-repellent group is represented by the formula “—O—SiR^{A}R^{B}—”. R^{A} and R^{B} in the formula each independently represent a hydrogen atom or a methyl group. In order to further suppress occurrence of image deletion of a formed image, the group represented by the formula (b2) is favorable as the group having a siloxane bond.

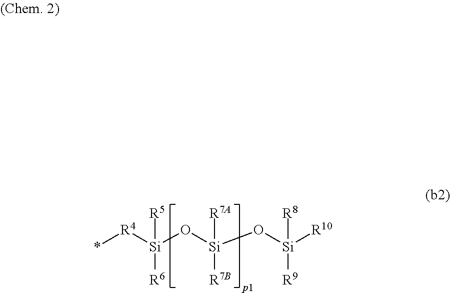

In the formula (b2), R⁴ represents an alkanediyl group having 1 or more and 6 or less carbon atoms. R⁵, R⁶, R^{7A}, R^{7B}, R⁸, and R⁹ each independently represent a hydrogen atom or a methyl group. R¹⁰ represents an alkyl group having 1 or more and 8 or less carbon atoms. p¹ represents the number of repetitions.

In the formula (b2), the alkanediyl group having 1 or more and 6 or less carbon atoms represented by R⁴ is favorably an alkanediyl group having 2 or more and 4 or less carbon atoms, more favorably an alkanediyl group having 3 carbon atoms. R⁵, R⁶, R^{7A}, R^{7B}, R⁸, and R⁹ favorably each represent a methyl group. The alkyl group having 1 or more and 8 or less carbon atoms represented by R¹⁰ is favorably an alkyl group having 1 or more and 6 or less carbon atoms, more favorably an alkyl group having 1 or more and 4 or less carbon atoms, and still more favorably a butyl group. The number of repetitions represented by p¹ is favorably the number of repetitions that will make the number average molecular weight of the monofunctional group unit 500 or more and 15000 or less, more favorably 1000 or more and 10000 or less, and still more favorably 1000.

Suitable examples of the monofunctional group unit include a repeating unit derived from a compound represented by a formula (EB-1).

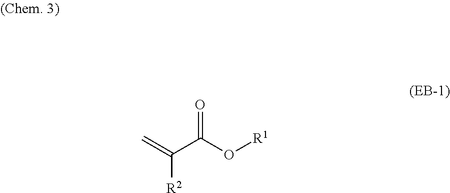

In the formula (EB-1), R¹ represents a water-repellent group and R² represents a hydrogen atom or a methyl group. The water-repellent group represented by R¹ is favorably the group represented by the formula (b1), an alkyl group having 10 or more and 18 or less carbon atoms, or a group having a siloxane bond, more favorably the group represented by the formula (b1). R² favorably represents a hydrogen atom.

A monofunctional group unit is formed by polymerizing the polymerizable functional group of the monofunctional group monomer. For example, a repeating unit represented by a formula (EB-1a), which is a monofunctional group unit, is formed by photocuring (more specifically, an addition polymerization reaction of a vinyl group) the compound represented by the formula (EB-1), which is a monofunctional group monomer.

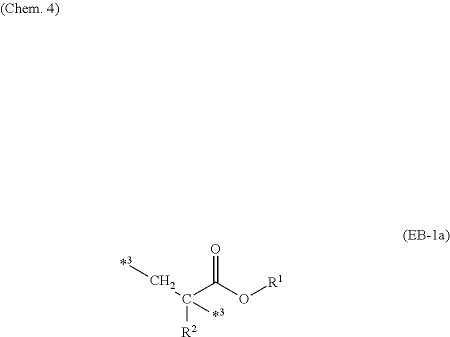

*³ in the formula (EB-1a) represents atomic bonding. *³ in one repeating unit represented by the formula (EB-1a) is bonded to *³ in a different repeating unit represented by the formula (EB-1a) or *² in a formula (Y-b) described below. R¹ and R² in the formula (EB-1a) are synonymous with R¹ and R² in the formula (EB-1).

As the compound represented by the formula (EB-1), which is an example of a monofunctional group monomer, a compound represented by a formula (C-3), (C-4), (C-6), (C-7), (C-8), or (C-9) is favorable. “iso-C₁₈H₃₇” in the formula (C-7) represents an isooctadecyl group. “n-C₁₈H₃₇” in the formula (C-8) represents an n-octadecyl group. “n-Bu” in the formula (C-9) represents an n-butyl group. p in the formula (C-9) is synonymous with p¹ in the formula (b2).

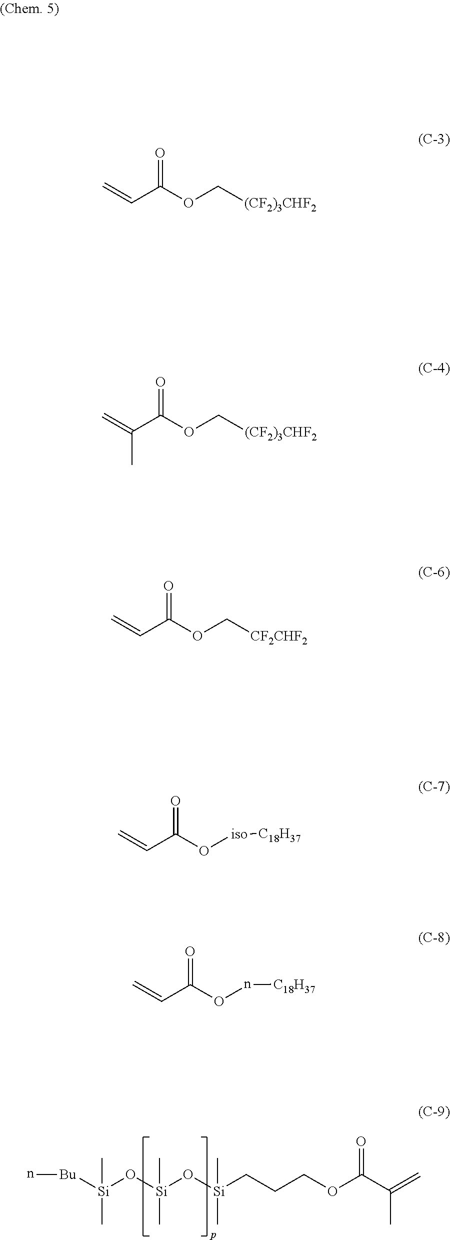

Next, the multifunctional group unit of the photocurable resin will be described. The multifunctional group unit is favorably a repeating unit derived from a compound having 2 or more and 10 or less polymerizable functional groups, more favorably a repeating unit derived from a compound having 3 or more and 6 or less polymerizable functional groups. Examples of the polymerizable functional group of the multifunctional group unit include those similar to the examples of the polymerizable functional group of the monofunctional group unit described above.

In order to adjust the water repellency of the protective layer to a suitable range and further suppress occurrence of image deletion of a formed image, it is favorable that the multifunctional group unit of the photocurable resin does not have a water-repellent group.

Examples of the multifunctional group monomer for forming a multifunctional group unit include a trimethylolpropane triacrylate, a glycerin triacrylate, a tris-(2-acryloxyethyl) isocyanurate, a pentaerythritol triacrylate, a pentaerythritol tetraacrylate, a ditrimethylolpropane tetraacrylate, a dipentaerythritol pentaacrylate, and a dipentaerythritol hexaacrylate. These multifunctional group monomers may be ethoxylated.

The multifunctional group monomer is favorably at least one selected from the group consisting of a pentaerythritol triacrylate, a pentaerythritol tetraacrylate, a dipentaerythritol pentaacrylate, and a dipentaerythritol hexaacrylate, more favorably one or two of them.

The above pentaerythritol triacrylate, pentaerythritol tetraacrylate, dipentaerythritol pentaacrylate, and dipentaerythritol hexaacrylate are respectively compounds represented by the following formulae (EA-1), (EA-2), (EA-3), and (EA-4). Therefore, the multifunctional group unit is favorably a repeating unit derived from at least one selected from the group consisting of the compounds represented by the formulae (EA-1), (EA-2), (EA-3), and (EA-4), more favorably a repeating unit derived from one or two of them. The multifunctional group unit is more favorably a repeating unit derived from at least one selected from the group consisting of the compounds represented by the formulae (EA-3) and (EA-4).

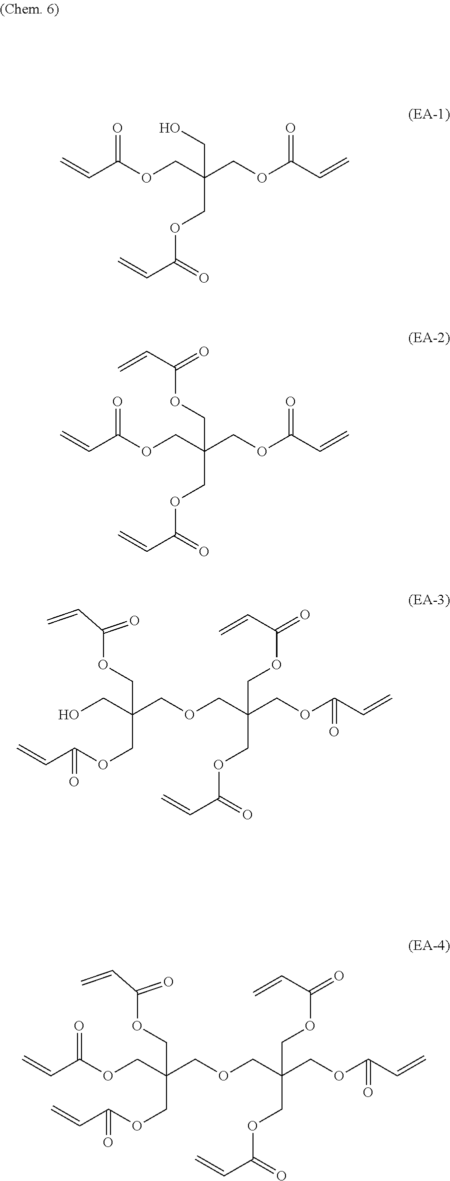

A multifunctional group unit is formed by polymerizing the polymerizable functional group of the multifunctional group monomer. For example, repeating units represented by the formulae (EA-1a), (EA-2a), (EA-3a), and (EA-4a), which are multifunctional group units, are respectively formed from the compounds represented by the formulae (EA-1), (EA-2), (EA-3), and (EA-4), which are multifunctional group monomers, by a photocuring reaction (more specifically, an addition polymerization reaction of a vinyl group).

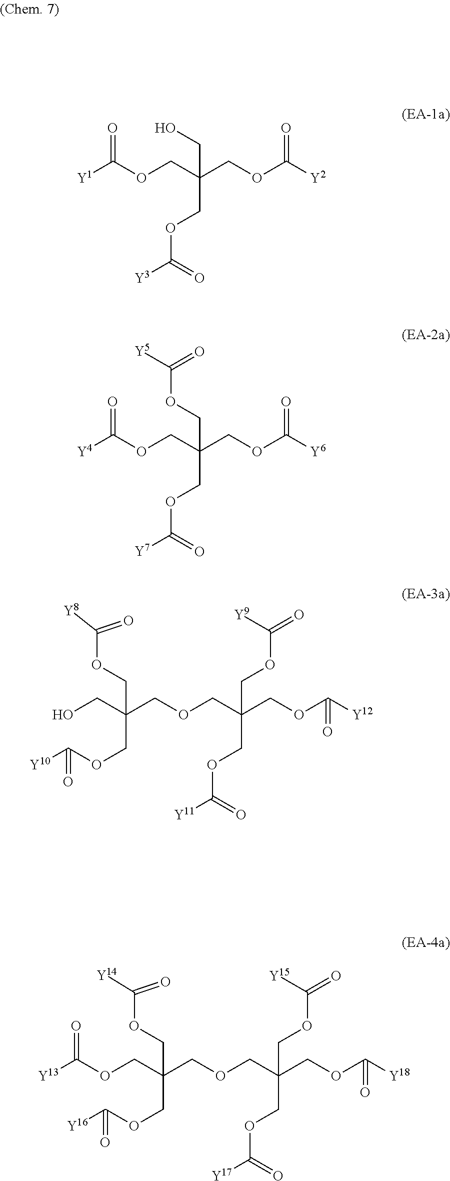

At least one of Y¹ to Y³ in the formula (EA-1a) represents a group represented by the formula (Y-b), and the remainder(s) of the at least one of Y¹ to Y³ represent(s) a group represented by the formula (Y-a). At least one of Y⁴ to Y⁷ in the formula (EA-2a) represents a group represented by the formula (Y-b), and the remainder(s) of the at least one of Y⁴ to Y⁷ represent(s) a group represented by the formula (Y-a). At least one of Y⁸ to Y¹² in the formula (EA-3a) represents a group represented by the formula (Y-b), and the remainder(s) of the at least one of Y⁸ to Y¹² represent(s) a group represented by the formula (Y-a). At least one of Y¹³ to Y¹⁸ in the formula (EA-3a) represents a group represented by the formula (Y-b), and the remainder(s) of the at least one of Y¹³ to Y¹⁸ represent(s) a group represented by the formula (Y-a).

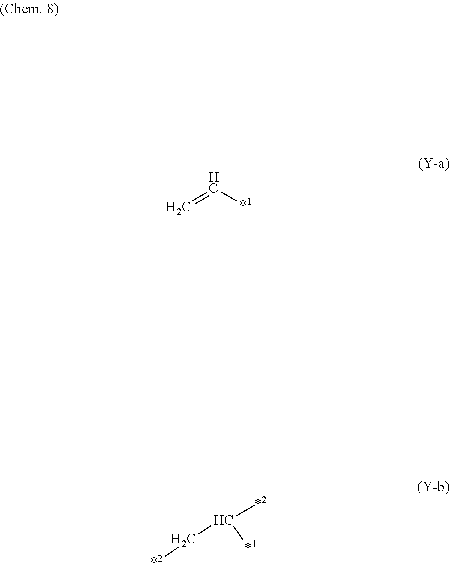

*¹ in the formulae (Y-a) and (Y-b) represents atomic bonding to be bonded to a carbon atom of a carbonyl group in the formulae (EA-1a) to (EA-4a). *² in the formula (Y-b) represents atomic bonding to be bonded to *² or *³ of a different repeating unit. That is, *² of the group represented by the formula (Y-b) of one repeating unit and *² of the group represented by the formula (Y-b) of another repeating unit or *³ in the formula (EB-1a) are bonded to each other.

The double bond of the group represented by the formula (Y-a) is cleaved by the photocuring reaction (more specifically, an addition polymerization reaction of a vinyl group) to form the group represented by the formula (Y-b). Therefore, as the photocuring reaction (more specifically, an addition polymerization reaction of a vinyl group) progresses, the group represented by the formula (Y-a) decreases and the group represented by the formula (Y-b) increases.

The multifunctional group monomer is favorably a mixture of a pentaerythritol triacrylate and a pentaerythritol tetraacrylate. The content ratio of the pentaerythritol triacrylate occupied in the mixture of the pentaerythritol triacrylate and the pentaerythritol tetraacrylate is favorably 40 mass % or more and 60% or less. The multifunctional group monomer is also favorably a mixture of a dipentaerythritol pentaacrylate and a dipentaerythritol hexaacrylate.

The hydroxyl value of the multifunctional group monomer is favorably 1 mgKOH/g or more and 50 mgKOH/g or less, more favorably 5 mgKOH/g or more and 15 mgKOH/g or less.

In order to cause the monofunctional group monomer to suitably enter the gap of the multifunctional group monomer to form a photocurable resin in which the multifunctional group unit and the monofunctional group unit are densely arranged, the multifunctional group unit is favorably larger than the monofunctional group unit. For the same reason, the molecular weight of multifunctional group monomer is favorably larger than the molecular weight of the monofunctional group monomer.

In order to promote the photocuring reaction and increase the hardness of the protective layer, a ratio M4/M3 of a mass M3 of the multifunctional group unit to a mass M4 of the monofunctional group unit is favorably 0.1 or more and 0.9 or less, more favorably 0.5 or more and 0.8 or less, and still more favorably 0.6 or more and 0.7 or less.

The content ratio of the multifunctional group unit occupied in all repeating units included in the photocurable resin is favorably 50 mass % or more and 90 mass % or less, more favorably 60 mass % or more and 70 mass % or less. The content ratio of the monofunctional group unit occupied in all repeating units included in the photocurable resin is favorably 10 mass % or more and 50 mass % or less, more favorably 30 mass % or more and 40 mass % or less. The total content ratio of the multifunctional group unit and the monofunctional group unit occupied in all repeating units included in the photocurable resin is favorably 80 mass % or more, more favorably 90 mass % or more, and particularly favorably 100 mass %.

The content ratio of the photocurable resin is favorably 50 mass % or more and 99 mass % or less, more favorably 70 mass % or more and 90 mass % or less, with respect to the mass of the protective layer.

### (Polymerization Initiator)

The polymerization initiator is, for example, a photopolymerization initiator. Examples of the photopolymerization initiator include an acylphosphine oxide compound, an acetophenone compound, a ketal compound, a benzoinether compound, an anthraquinone compound, and a thioxanthone compound. An acylphosphine oxide compound is favorable as a photopolymerization initiator because it has high ultraviolet absorption efficiency. Examples of the acylphosphine oxide compound include 2,4,6-trimethylbenzoyl-diphenylphosphineoxide, phenylbis(2,4,6-trimethylbenzoyl)phosphineoxide, and lithiumphenyl(2,4,6-trimethylbenzoyl)phosphonate. The content ratio of the polymerization initiator is favorably 1 mass % or more and 20 mass % or less, more favorably 5 mass % or more and 10 mass % or less, with respect to the mass of the protective layer.

### (Additive)

Examples of the additive included in the protective layer include a leveling agent (e.g., silicone oil and a leveling agent containing a halogen atom) and other known additives. As the leveling agent, a leveling agent containing a halogen atom is favorable, an acrylic polymer containing a halogen atom is more favorable, a fluorosilicone modified acrylic polymer is still more favorable, and a UV curable fluorosilicone modified acrylic polymer is particularly favorable. The leveling agent favorably has a polymerizable functional group. In the case where the leveling agent has a polymerizable functional group, the photocurable resin includes a repeating unit derived from a leveling agent as a repeating unit. In the case where the leveling agent has a polymerizable functional group, the polymerizable functional group equivalent (e.g., the vinyl group equivalent) of the leveling agent is favorably 100 g/mol or more and 500 g/mol or less, more favorably 260 g/mol or more and 450 g/mol or less. Note that it is favorable that the protective layer does not include a charge generating agent, a hole transporting agent, and an electron transporting agent.

### <Photosensitive Layer>

The photosensitive layer includes a charge generating agent, a hole transporting agent, and a binder resin. In the case where the photoreceptor is a single-layer photoreceptor, the single-layer photosensitive layer that is a photosensitive layer includes a charge generating agent, a hole transporting agent, and a binder resin. The single-layer photosensitive layer favorably further includes an electron transporting agent. The single-layer photosensitive layer may further include an additive, as necessary.

In the case where the photoreceptor is a stacked photoreceptor, the charge generating layer included in the photosensitive layer includes a charge generating agent. The charge transporting layer included in the photosensitive layer includes a hole transporting agent and a binder resin. The charge generating layer may further include a base resin, as necessary. Each of the charge generating layer and the charge transporting layer may further include an additive, as necessary. Each of the charge generating layer and the charge transporting layer may include a radical acceptor compound. However, each of the charge generating layer and the charge transporting layer does not necessarily need to include a radical acceptor compound.

### (Charge Generating Agent)

Examples of the charge generating agent include a phthalocyanine pigment, a perylene pigment, a bisazo pigment, a trisazo pigment, a dithioketopyrrolopyrrole pigment, a metal-free naphthalocyanine pigment, a metal naphthalocyanine pigment, a squaraine pigment, an indigo pigment, an azulenium pigment, a cyanine pigment, a powder of inorganic photoconductive materials (e.g., selenium, selenium-tellurium, selenium-arsenic, cadmium sulfide, and amorphous silicon), a pyrylium pigment, an anthanthron pigment, a triphenylmethane pigment, a threne pigment, a toluidine pigment, a pyrazoline pigment, and a quinacridone pigment.

The phthalocyanine pigment has a phthalocyanine structure. Examples of the phthalocyanine pigment include metal phthalocyanine and metal-free phthalocyanine. Examples of the metal phthalocyanine include titanyl phthalocyanine, hydroxygallium phthalocyanine, and chlorogallium phthalocyanine. As the metal phthalocyanine, titanyl phthalocyanine is favorable. The titanyl phthalocyanine is represented by the formula (CG-1). The metal-free phthalocyanine is represented by the formula (CG-2).

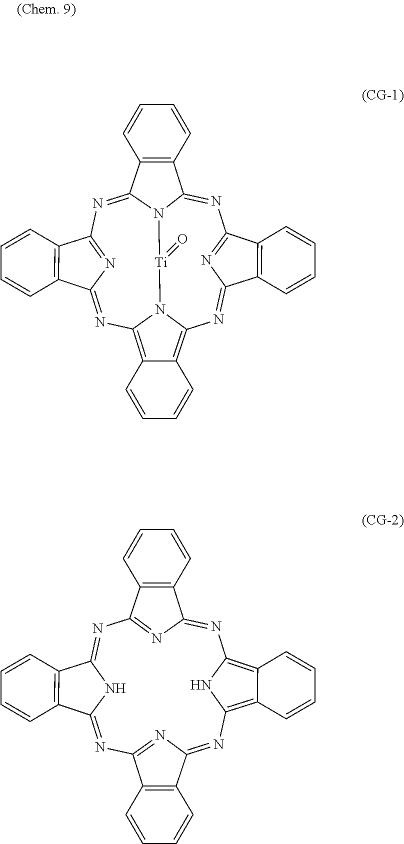

The phthalocyanine pigment may be crystalline or non-crystalline. Examples of the crystal of the metal-free phthalocyanine include an X-type crystal of the metal-free phthalocyanine (hereinafter, referred to as an X-type metal-free phthalocyanine in some cases). Examples of the crystal of the titanyl phthalocyanine include α-type, β-type, and Y-type crystals of the titanyl phthalocyanine (hereinafter, respectively referred to as α-type, β-type, and Y-type titanyl phthalocyanines in some cases).

For example, for a digital optical image forming apparatus (e.g., a laser beam printer or a facsimile machine using a light source such as semiconductor laser light), it is favorable to use a photoreceptor having sensitivity in a wavelength region of 700 nm or more. As the charge generating agent, a phthalocyanine pigment is favorable, titanyl phthalocyanine or metal-free phthalocyanine is more favorable, and Y-type titanyl phthalocyanine or X-type metal-free phthalocyanine is particularly favorable because they have a high quantum yield in the wavelength region of 700 nm or more.

The Y-type titanyl phthalocyanine has a main peak at, for example, 27.2° of the Bragg angle (2θ±0.2°) in the CuKα characteristic X-ray diffraction spectrum. The main peak in the CuKα characteristic X-ray diffraction spectrum is a peak having the first or second highest intensity in the range of the Bragg angle (2θ±0.2°) of 3° or more and 40° or less. The Y-type titanyl phthalocyanine does not have a peak at 26.2° in the CuKα characteristic X-ray diffraction spectrum.

The CuKα characteristic X-ray diffraction spectrum can be measured by, for example, the following method. First, a sample holder of an X-ray diffractometer (e.g., “RINT (registered trademark) 1100” manufactured by Rigaku Holdings Corporation and its Global Subsidiaries) is filled with a sample (titanyl phthalocyanine) to measure the X-ray diffraction spectrum under the conditions of an X-ray tube Cu, a tube voltage of 40 kV, a tube current of 30 mA, and a wavelength of CuKα characteristic X-rays of 1.542 Å. The measurement range (2θ) is, for example, 3° or more and 40° or less (start angle of 3°, stop angle of 40°), and the scanning speed is, for example, 10°/min. The main peak is determined from the obtained X-ray diffraction spectrum, and the Bragg angle of the main peak is read.

In the case where the photoreceptor is a single-layer photoreceptor, the content of the charge generating agent is favorably 0.1 parts by mass or more and 50 parts by mass or less, more favorably 0.5 parts by mass or more and 30 parts by mass or less, with respect to 100 parts by mass of the binder resin. In the case where the photoreceptor is a stacked photoreceptor, the content of the charge generating agent is favorably 10 parts by mass or more and 300 parts by mass or less, more favorably 100 parts by mass or more and 200 parts by mass or less, with respect to 100 parts by mass of the base resin.

### (Hole Transporting Agent)

Examples of the hole transporting agent include a triphenylamine derivative, a diamine derivative (e.g., an N,N,N′,N′-tetraphenylbenzidine derivative, an N,N,N′,N′-tetraphenylphenylenediamine derivative, an N,N,N′,N′-tetraphenylnaphthylenediamine derivative, an N,N,N′,N′-tetraphenylphenanthrylenediamine derivative, and a di(aminophenylethenyl)benzene derivative)), an oxadiazole compound (e.g., 2,5-di(4-methylaminophenyl)-1,3,4-oxadiazole), a styryl compound (e.g., 9-(4-diethylaminostyryl)anthracene), a carbazole compound (e.g., polyvinylcarbazole), an organic polysilane compound, a pyrazoline compound (e.g., 1-phenyl-3-(p-dimethylaminophenyl)pyrazoline), a hydrazone compound, an indole compound, an oxazole compound, an isooxazole compound, a thiazole compound, a thiadiazole compound, an imidazole compound, a pyrazole compound, and a triazole compound.

In order to improve the sensitivity of the photoreceptor, the hole transporting agent favorably includes at least one of compounds represented by the formulae (1), (2), and (3). Hereinafter, the compounds represented by the formulae (1), (2), and (3) will be respectively referred to as hole transporting agents (1), (2), and (3) in some cases.

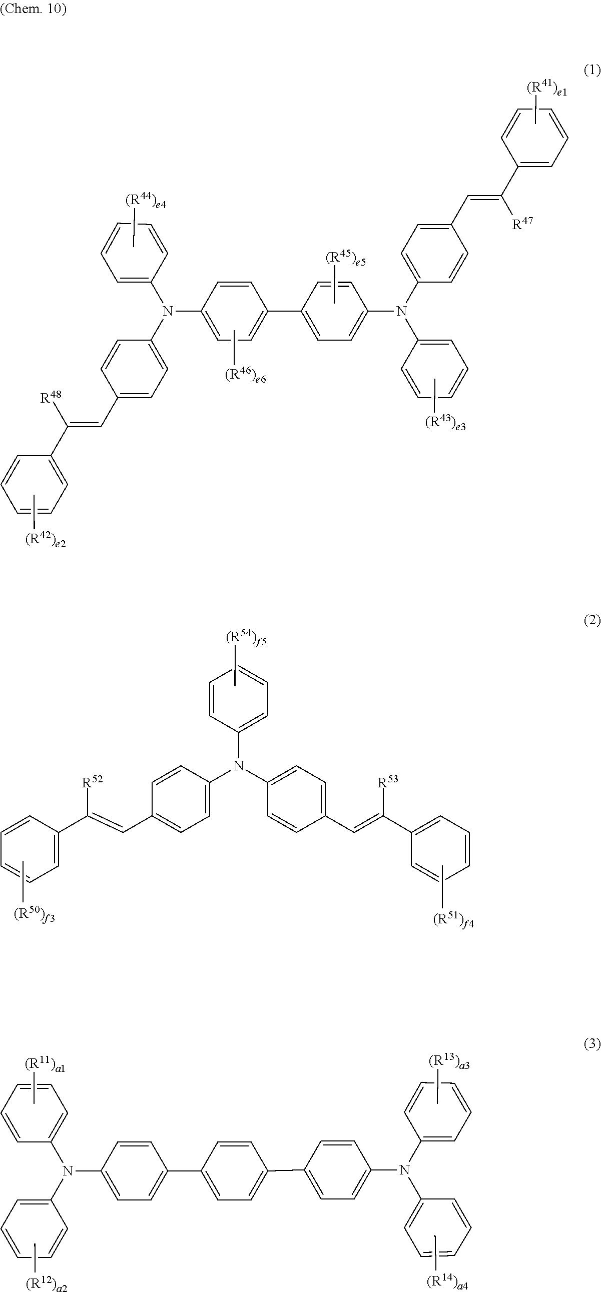

In the formula (1), R⁴¹, R⁴², R⁴³, R⁴⁴, R⁴⁵, and R⁴⁶ each independently represent an alkyl group having 1 or more and 8 or less carbon atoms or a phenyl group. R⁴⁷ and R⁴⁸ each independently represent a hydrogen atom, an alkyl group having 1 or more and 8 or less carbon atoms, or a phenyl group. e₁, e₂, e₃, and e₄ each independently represent an integer of 0 or more and 5 or less. e₅ and e₆ each independently represent an integer of 0 or more and 4 or less.

In the formula (1), when e₁ represents an integer of 2 or more and 5 or less, a plurality of R⁴¹ may represent the same group or different groups. When e₂ represents an integer of 2 or more and 5 or less, a plurality of R⁴² may represent the same group or different groups. When e₃ represents an integer of 2 or more and 5 or less, a plurality of R⁴³ may represent the same group or different groups. When e₄ represents an integer of 2 or more and 5 or less, a plurality of R⁴⁴ may represent the same group or different groups. When e₅ represents an integer of 2 or more and 4 or less, a plurality of R⁴⁵ may represent the same group or different groups. When e₆ represents an integer of 2 or more and 4 or less, a plurality of R⁴⁶ may represent the same group or different groups.

In the formula (1), R⁴¹ to R⁴⁶ each independently represent favorably an alkyl group having 1 or more and 8 or less carbon atoms, more favorably an alkyl group having 1 or more and 3 or less carbon atoms, and still more favorably a methyl group or an ethyl group. R⁴⁷ and R⁴⁸ favorably each represent a hydrogen atom. It is favorable that e₁, e₂, e₃, and e₄ each independently represent an integer of 0 or more and 2 or less, and it is more favorable that e₁ and e₂ each represent 0 and e₃ and e₄ each represent 2. e₅ and e₆ favorably each represent 0.

In the formula (2), R⁵⁰, R⁵¹, and R⁵⁴ each independently represent an alkyl group having 1 or more and 8 or less carbon atoms or a phenyl group. R⁵² and R⁵³ each independently represent a hydrogen atom, an alkyl group having 1 or more and 8 or less carbon atoms, or a phenyl group that may be substituted with an alkyl group having 1 or more and 8 or less carbon atoms. f₃, f₄, and f₅ each independently represent an integer of 0 or more and 5 or less.

In the formula (2), when f₃ represents an integer of 2 or more and 5 or less, a plurality of R⁵⁰ may represent the same group or different groups. When f₄ represents an integer of 2 or more and 5 or less, a plurality of R⁵¹ may represent the same group or different groups. When f₅ represents an integer of 2 or more and 5 or less, a plurality of R⁵⁴ may represent the same group or different groups.

In the formula (2), R⁵⁰, R⁵¹, and R⁵⁴ favorably each independently represent an alkyl group having 1 or more and 8 or less carbon atoms, more favorably an alkyl group having 1 or more and 3 or less carbon atoms, and still more favorably a methyl group. R⁵² and R⁵³ favorably each independently represent a hydrogen atom, an unsubstituted phenyl group, or a phenyl group substituted with an alkyl group having 1 or more and 8 or less carbon atoms. In the case where the phenyl group is substituted with an alkyl group having 1 or more and 8 or less carbon atoms, as such an alkyl group having 1 or more and 8 or less carbon atoms, an alkyl group having 1 or more and 3 or less carbon atoms is favorable and a methyl group is more favorable. f₃, f₄, and f₅ favorably each independently represent 0 or 1.

In the formula (3), R¹¹, R¹², R¹³, and R¹⁴ each independently represent an alkyl group having 1 or more and 8 or less carbon atoms or a phenyl group. a₁, a₂, a₃, and a₄ each independently represent an integer of 0 or more and 5 or less.

In the formula (3), when a₁ represents an integer of 2 or more and 5 or less, a plurality of R¹¹ may represent the same group or different groups. When a₂ represents an integer of 2 or more and 5 or less, a plurality of R¹² may represent the same group or different groups. When a₃ represents an integer of 2 or more and 5 or less, a plurality of R¹³ may represent the same group or different groups. When a₄ represents an integer of 2 or more and 5 or less, a plurality of R¹⁴ may represent the same group or different groups.

In the formula (3), R¹¹, R¹², R¹³, and R¹⁴ favorably each independently represent an alkyl group having 1 or more and 3 or less carbon atoms, more favorably a methyl group or an ethyl group. a₁, a₂, a₃, and a₄ favorably each independently represent an integer of 1 or more and 3 or less, more favorably 1.

Suitable examples of the hole transporting agent include compounds represented by the formulae (HT-2), (HT-3), and (HT-4) (hereinafter, respectively referred to as hole transporting agents (HT-2), (HT-3), and (HT-4) in some cases).

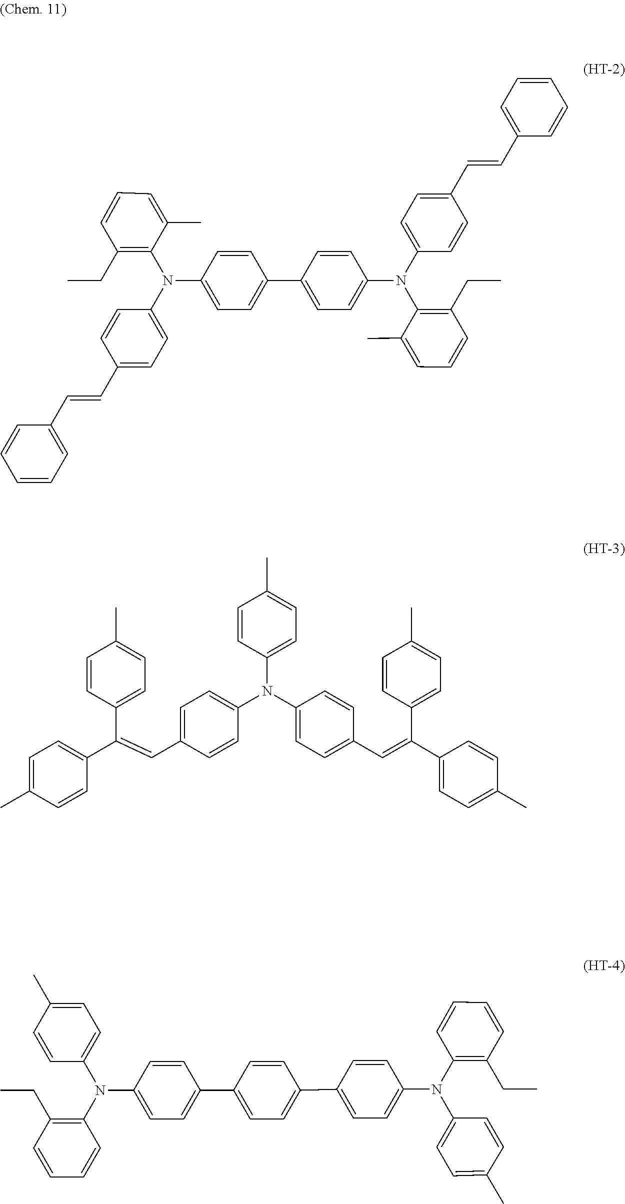

The content ratio of the hole transporting agents (1) to (3) is favorably 80 mass % or more, more favorably 90 mass % or more, and still more favorably 100 mass %, with respect to the total mass of the hole transporting agents.

In the case where ultraviolet rays are applied in the protective layer forming step, in order to suppress decomposition of the hole transporting agent due to irradiation of ultraviolet rays, the hole transporting agent favorably has two or less (one or two) chain ethene-1,2-diyl groups or no chain ethene-1,2-diyl group. Hereinafter, the “chain ethene-1,2-diyl group” will be referred to as a “predetermined double bond” in some cases. The predetermined double bond is a bond represented by the following formula (DB). In the formula (DB), * represents atomic bonding. The predetermined double bond is an unsubstituted ethene-1,2-diyl group. The predetermined double bond is a double bond forming a chain group because it is chain. The predetermined double bond is not a double bond forming a ring such as a benzene ring because it is chain.

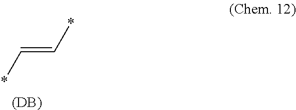

In the case where ultraviolet rays are applied in the protective layer forming step, in order to suppress decomposition of the hole transporting agent due to irradiation of ultraviolet rays, the content ratio of the hole transporting agent having two or less predetermined double bonds or no predetermined double bond is favorably 80 mass % or more, more favorably 90 mass % or more, and still more favorably 100 mass %, with respect to the mass of the hole transporting agent.

In the case where the photoreceptor is a single-layer photoreceptor, the content of the hole transporting agent is favorably 10 parts by mass or more and 200 parts by mass or less, more favorably 80 parts by mass or more and 130 parts by mass or less, with respect to 100 parts by mass of the binder resin.

In order to improve the sensitivity of the photoreceptor, in the case where the photoreceptor is a single-layer photoreceptor, the total content ratio of the hole transporting agent and the electron transporting agent is favorably 40 mass % or more, more favorably 40 mass % or more and 60 mass % or less, with respect to the mass of the single-layer photosensitive layer.

In the case where the photoreceptor is a stacked photoreceptor, the content of the hole transporting agent is favorably 10 parts by mass or more and 200 parts by mass or less, more favorably 50 parts by mass or more and 100 parts by mass or less, with respect to 100 parts by mass of the binder resin.

In order to improve the sensitivity of the photoreceptor, in the case where the photoreceptor is a stacked photoreceptor, the content ratio of the hole transporting agent is favorably 40.0 mass % or more, more favorably 40.0 mass % or more and 60.0 mass % or less, with respect to the mass of the charge transporting layer.

### (Electron Transporting Agent)

Examples of the electron transporting agent include a quinone compound, a diimide compound, a hydrazone compound, a malononitrile compound, a thiopyran compound, a trinitrothioxanthone compound, a 3,4,5,7-tetranitro-9-fluorenone compound, a dinitroanthracene compound, a dinitroacridine compound, tetracyanoethylene, 2,4,8-trinitrothioxanthone, dinitrobenzene, dinitroacridine, succinic anhydride, maleic anhydride, and dibromomaleic anhydride. Examples of the quinone compound include a diphenoquinone compound, an azoquinone compound, an anthraquinone compound, a naphthoquinone compound, a nitroanthraquinone compound, and a dinitroanthraquinone compound.

The electron transporting agent favorably includes at least one of compounds represented by the formulae (11), (12), (13), (14), (15), and (16). Hereinafter, the compounds represented by the formulae (11), (12), (13), (14), (15), and (16) will be respectively referred to as electron transporting agents (11), (12), (13), (14), (15), and (16) in some cases.

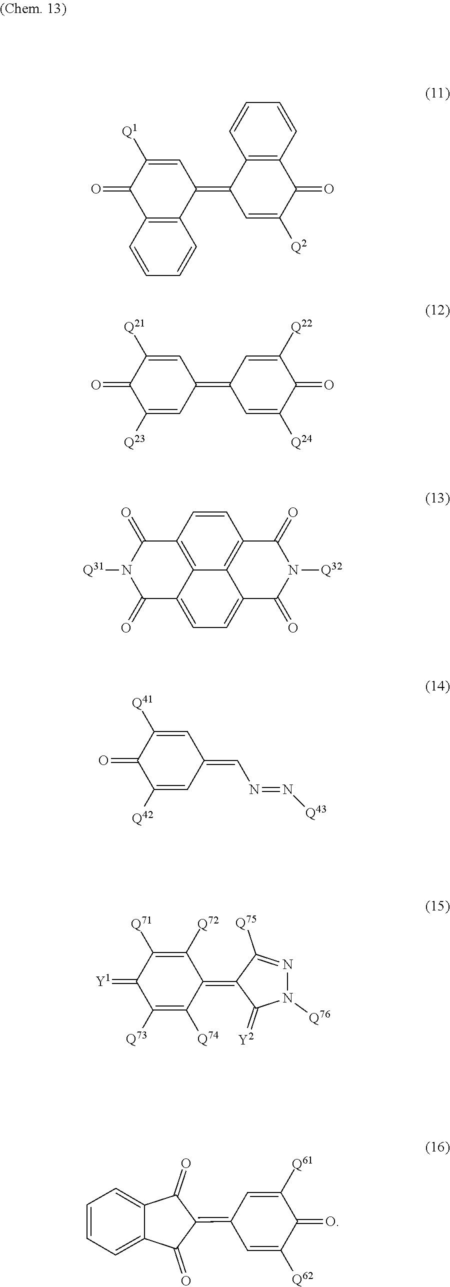

Q¹ and Q² in the formula (11), Q²¹, Q²², Q²³, and Q²⁴ in the formula (12), Q³¹ and Q³² in the formula (13), Q⁴¹, Q⁴², and Q⁴³ in the formula (14), Q⁷¹, Q⁷², Q⁷³, Q⁷⁴, Q⁷⁵, and Q⁷⁶ in the formula (15), and Q⁶¹ and Q⁶² in the formula (16) each independently represent a hydrogen atom, a halogen atom, a cyano group, an alkyl group having 1 or more and 6 or less carbon atoms, an alkenyl group having 2 or more and 6 or less carbon atoms, an alkoxy group having 1 or more and 6 or less carbon atoms, or an aryl group having 6 or more and 14 or less carbon atoms, which may be substituted with at least one substituent group selected from the group consisting of an alkyl group having 1 or more and 6 or less carbon atoms and a halogen atom. Y¹ and Y² in the formula (15) each represent an oxygen atom.

Q¹ and Q² in the formula (11), Q²¹, Q²², Q²³, and Q²⁴ in the formula (12), Q³¹ and Q³² in the formula (13), Q⁴¹, Q⁴², and Q⁴³ in the formula (14), Q⁷¹, Q⁷², Q⁷³, Q⁷⁴, Q⁷⁵, and Q⁷⁶ in the formula (15), and Q⁶¹ and Q⁶² in the formula (16) favorably each independently represent a hydrogen atom, an alkyl group having 1 or more and 6 or less carbon atoms, or an aryl group having 6 or more and 14 or less carbon atoms, which may be substituted with at least one substituent group selected from the group consisting of an alkyl group having 1 or more and 6 or less carbon atoms and a halogen atom.

As the alkyl group having 1 or more and 6 or less carbon atoms represented by Q¹ and Q² in the formula (11), Q²¹, Q²², Q²³, and Q²⁴ in the formula (12), Q³¹ and Q³² in the formula (13), Q⁴¹, Q⁴², and Q⁴³ in the formula (14), Q⁷¹, Q⁷², Q⁷³, Q⁷⁴, Q⁷⁵, and Q⁷⁶ in the formula (15), and Q⁶¹ and Q⁶² in the formula (16), an alkyl group having 1 or more and 5 or less carbon atoms is favorable, a methyl group, an ethyl group, a propyl group, a butyl group, or a pentyl group is more favorable, and a methyl group, a tert-butyl group, or a 1,1-dimethylpropyl group is particularly favorable.

As the aryl group having 6 or more and 14 or less carbon atoms represented by Q¹ and Q² in the formula (11), Q²¹, Q²², Q²³, and Q²⁴ in the formula (12), Q³¹ and Q³² in the formula (13), Q⁴¹, Q⁴², and Q⁴³ in the formula (14), Q⁷¹, Q⁷², Q⁷³, Q⁷⁴, Q⁷⁵, and Q⁷⁶ in the formula (15), and Q⁶¹ and Q⁶² in the formula (16), an aryl group having 6 or more and 10 or less carbon atoms is favorable and a phenyl group is more favorable. The aryl group having 6 or more and 14 or less carbon atoms may be substituted with at least one substituent group selected from the group consisting of an alkyl group having 1 or more and 6 or less carbon atoms and a halogen atom. As such an alkyl group having 1 or more and 6 or less carbon atoms, an alkyl group having 1 or more and 3 or less carbon atoms is favorable and a methyl group or an ethyl group is more favorable. As the halogen atom that is a substituent group, a fluorine atom, a chlorine atom, or a bromine atom is favorable and a chlorine atom is particularly favorable. In the case where the aryl group having 6 or more and 14 or less carbon atoms is substituted with a substituent group, the number of substituent groups is favorably 1 or more and 5 or less, more favorably 1 or 2. As the aryl group having 6 or more and 14 or less carbon atoms substituted with at least one substituent group selected from the group consisting of an alkyl group having 1 or more and 6 or less carbon atoms and a halogen atom, a chlorophenyl group, a dichlorophenyl group, or an ethylmethylphenyl group is favorable and a 4-chlorophenyl group, a 2,5-dichlorophenyl group, or a 2-ethyl-6-methylphenyl group is more favorable.

Suitable examples of the electron transporting agent include compounds represented by formulae (ET-1) to (ET-7) (hereinafter, respectively referred to as electron transporting agents (ET-1) to (ET-7) in some cases).

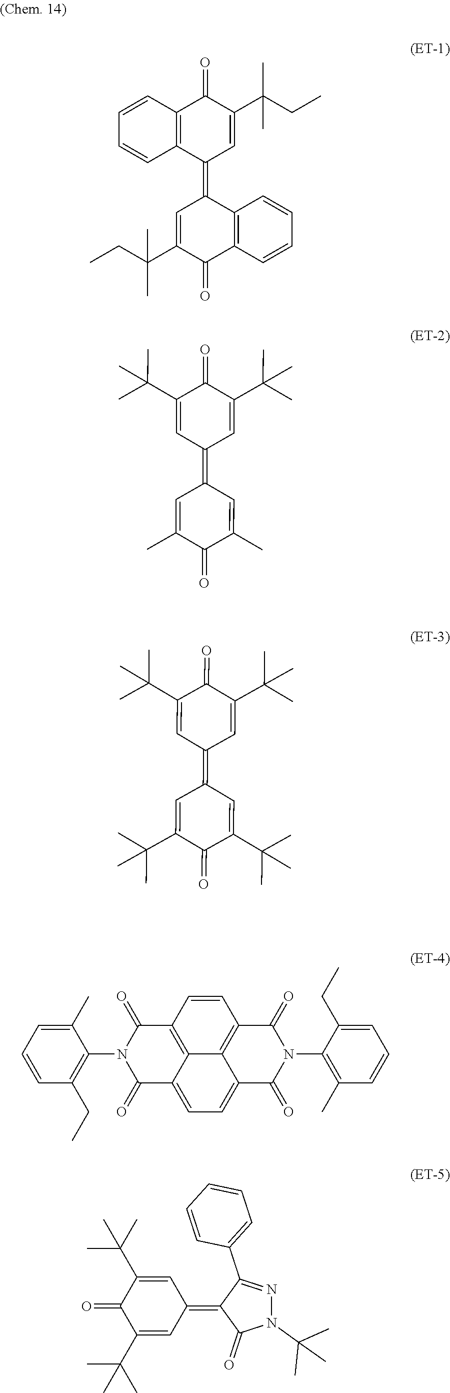

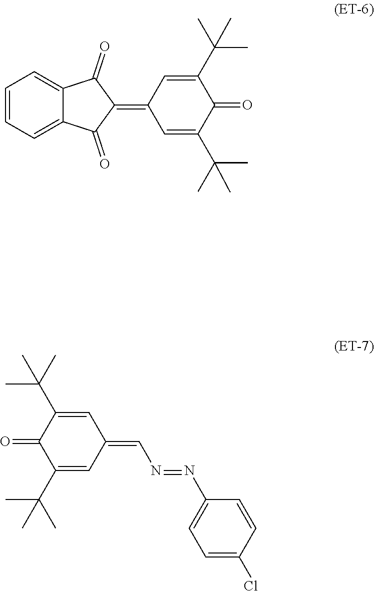

The content ratio of the electron transporting agents (11) to (16) is favorably 80 mass % or more, more favorably 90 mass % or more, and still more favorably 100 mass %, with respect to the mass of the electron transporting agent.

In the case where the photoreceptor is a single-layer photoreceptor, the content of the electron transporting agent is favorably 5 parts by mass or more and 150 parts by mass or less, more favorably 10 parts by mass or more and 50 parts by mass or less, with respect to 100 parts by mass of the binder resin.

### (Binder Resin)

Examples of the binder resin include a thermoplastic resin (more specifically, a polyarylate resin, a polycarbonate resin, a styrene resin, a styrene-butadiene copolymer, a styrene-acrylonitrile copolymer, a styrene-maleic acid copolymer, a styrene-acrylic acid copolymer, an acrylic copolymer, a polyethylene resin, an ethylene-vinyl acetate copolymer, a chlorinated polyethylene resin, a polyvinyl chloride resin, a polypropylene resin, an ionomer, a vinyl chloride-vinyl acetate copolymer, a polyester resin, an alkyd resin, a polyamide resin, a polyurethane resin, a polysulfone resin, a diallylphthalate resin, a ketone resin, a polyvinylbutyral resin, a polyvinylacetal resin, and a polyether resin), a thermosetting resin (more specifically, a silicone resin, an epoxy resin, a phenolic resin, a urea resin, a melamine resin, and a cross-linkable thermosetting resin other than these), and a photocurable resin (more specifically, an epoxy-acrylic acid resin and a urethane-acrylic acid copolymer).

Of these resins, a polycarbonate resin is favorable because a single-layer photosensitive layer and a charge transporting layer having an excellent balance of workability, mechanical strength, optical characteristics, and wear resistance can be obtained. Examples of the polycarbonate resin include a bisphenol Z-type polycarbonate resin, a bisphenol B-type polycarbonate resin, a bisphenol ZC-type polycarbonate resin, a bisphenol C-type polycarbonate resin, and a bisphenol A-type polycarbonate resin. As the binder resin, a bisphenol Z-type polycarbonate resin or a bisphenol B-type polycarbonate resin is favorable. The bisphenol Z-type polycarbonate resin is a resin including a repeating unit represented by the formula (BisZ). The bisphenol B-type polycarbonate resin is a resin including a repeating unit represented by the formula (BisB).

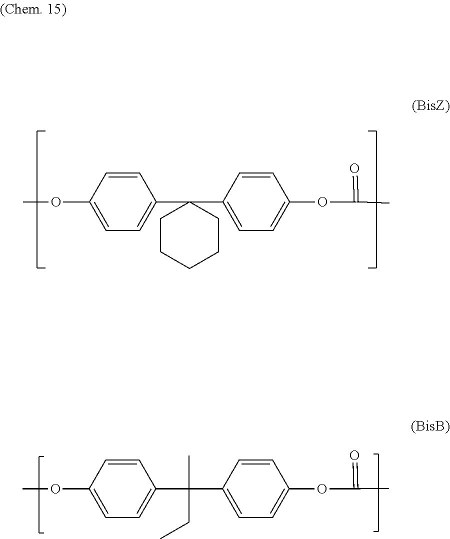

### (Base Resin)

Examples of the base resin included in the charge generating layer are the same as the examples of the binder resin included in the charge transporting layer. However, in order to suitably form a charge generating layer and a charge transporting layer, it is favorable to select, as a base resin, a resin different from the resin used as the binder resin, of the above examples of the binder resin. The base resin is, for example, a polyvinylacetal resin.

### (Additive)

Examples of the additive included in the photosensitive layer include an ultraviolet absorber, an antioxidant, a radical scavenger, a singlet quencher, a softener, a surface modifier, a bulking agent, a thickener, a dispersion stabilizer, a wax, a donor, a surfactant, a plasticizer, a sensitizer, an electron acceptor compound, and a leveling agent. Examples of the leveling agent include silicone oil, more specifically, dimethylsilicone oil.

### <Intermediate Layer>

The presence of the intermediate layer makes the flow of currents generated when the photoreceptor is exposed smooth and makes it possible to suppress an increase in resistance, while maintaining the insulated state to the extent that leakage can be suppressed. The intermediate layer (undercoat layer) includes, for example, one or both of an inorganic particle and an organic particle, and a resin used for the intermediate layer (intermediate layer resin). Hereinafter, the inorganic particle and the organic particle included in the intermediate layer will be collectively referred to as an intermediate layer particle. The ratio of the mass of the intermediate layer particle with respect to the mass of the intermediate layer resin is, for example, 1 or more and 4 or less. The thickness of the intermediate layer is, for example, 0.1 μm or more and 5 μm or less.

Examples of the inorganic particle of the intermediate layer particle include a white pigment (more specifically, titanium oxide, zinc oxide, zinc flower, zinc sulfide, white lead, lithopone, and the like), and an extender pigment (more specifically, alumina, calcium carbonate, barium sulfate, and the like). Examples of the organic particle of the intermediate layer particle include a fluoropolymer particle, a benzoguanamine resin particle, and a styrene resin particle. The number average primary particle size of the intermediate layer particle is favorably 100 nm or less, more favorably 1 nm or more and 50 nm or less. As the intermediate layer particle, an inorganic particle is favorable and titanium oxide is more favorable. Titanium oxide may be subjected to surface treatment. The surface treatment of titanium oxide may be performed once or a plurality of times (e.g., twice). Examples of the surface treatment agent used for the surface treatment of titanium oxide include alumina, silica, and an organosilicon compound (e.g., polysiloxane, more specifically methylhydrogenpolysiloxane).

Examples of the intermediate layer resin are the same as the examples of the binder resin included in the photosensitive layer. However, in order to suitably form a photosensitive layer, it is favorable to select, as an intermediate layer resin, a resin different from the resin used as the binder resin, of the above examples of the binder resin. The intermediate layer resin is, for example, a polyamide resin.

### <Conductive Substrate>

The conductive substrate is not particularly limited, and at least the surface portion thereof only needs to be formed of a material having conductivity. One example of the conductive substrate is a conductive substrate formed of a material having conductivity. Another example of the conductive substrate is a conductive substrate covered with a material having conductivity. Examples of the material having conductivity include aluminum, iron, copper, tin, platinum, silver, vanadium, molybdenum, chromium, cadmium, titanium, nickel, palladium, and indium. Two or more materials having conductivity may be combined and used as an alloy (more specifically, an aluminum alloy, stainless steel, brass, or the like). As the material having conductivity, aluminum and an aluminum alloy are favorable because they provide good charge transfer from the photosensitive layer to the conductive substrate. The shape of the conductive substrate is appropriately selected in accordance with the structure of the image forming apparatus. Examples of the shape of the conductive substrate include a sheet shape and a drum shape. Further, the thickness of the conductive substrate is appropriately selected in accordance with the shape of the conductive substrate.

### <Method of Producing Photoreceptor>

Next, an example of a method of producing the photoreceptor according to the first embodiment will be described. The method of producing the photoreceptor according to the first embodiment include, for example, a photosensitive layer forming step and a protective layer forming step.

### (Step of Forming Photosensitive Layer of Single-Layer Photoreceptor)

A photosensitive layer forming step in the case where the photoreceptor is a single-layer photoreceptor will be described. The step of forming a photosensitive layer of a single-layer photoreceptor includes a single-layer photosensitive layer forming step. In the single-layer photosensitive layer forming step, a coating liquid for forming a single-layer photosensitive layer (hereinafter, referred to as a coating liquid for a single-layer photosensitive layer in some cases) is prepared. The coating liquid for a single-layer photosensitive layer includes, for example, a charge generating agent, a hole transporting agent, a binder resin, a solvent, an electron transporting agent as necessary, and an additive as necessary. The coating liquid for a single-layer photosensitive layer is prepared by mixing these. Subsequently, the coating liquid for a single-layer photosensitive layer is applied onto the conductive substrate. Subsequently, at least part of the solvent included in the applied coating liquid for a photosensitive layer is removed to form a single-layer photosensitive layer.

### (Step of Forming Photosensitive Layer of Stacked Photoreceptor)

A photosensitive layer forming step in the case where the photoreceptor is a stacked photoreceptor will be described. The step of forming a photosensitive layer of a stacked photoreceptor includes a charge generating layer forming step and a charge transporting layer forming step.

In the charge generating layer forming step, a coating liquid for forming a charge generating layer (hereinafter, referred to as a coating liquid for a charge generating layer in some cases) is prepared. The coating liquid for a charge generating layer includes, for example, a charge generating agent, a base resin, a solvent, and an additive as necessary. The coating liquid for a charge generating layer is prepared by mixing these. Subsequently, the coating liquid for a charge generating layer is applied onto the conductive substrate. Subsequently, at least part of the solvent included in the applied coating liquid for a charge generating layer is removed to form a charge generating layer.

In the charge transporting layer forming step, a coating liquid for forming a charge transporting layer (hereinafter, referred to as a coating liquid for a charge transporting layer in some cases) is prepared. The coating liquid for a charge transporting layer includes a hole transporting agent, a binder resin, a solvent, and an additive as necessary. The coating liquid for a charge transporting layer is prepared by mixing these. Subsequently, the coating liquid for a charge transporting layer is applied onto the charge generating layer. Subsequently, at least part of the solvent included in the applied coating liquid for a charge transporting layer is removed to form a charge transporting layer.

### (Protective Layer Forming Step)

In the protective layer forming step, a protective layer is formed on the photosensitive layer. First, a coating liquid for forming a protective layer (hereinafter, referred to as a coating liquid for a protective layer in some cases) is prepared. The coating liquid for a protective layer includes a tin oxide particle, an alumina particle, at least one compound for forming the protective layer resin, a solvent, a polymerization initiator as necessary, and an additive as necessary. The coating liquid for a protective layer is prepared by mixing these. Subsequently, the coating liquid for a protective layer is applied onto the photosensitive layer. Subsequently, the at least one compound for forming the protective layer resin included in the coating liquid for a protective layer on the photosensitive layer is polymerized. The polymerization forms a protective layer resin that is a polymerized product.

In the case where the protective layer resin is a photocurable resin, ultraviolet rays are applied to the coating liquid for a protective layer to polymerize the at least one compound for forming the protective layer resin included in the coating liquid for a protective layer. The ultraviolet rays to be applied in the protective layer forming step are applied from, for example, a light-emitting diode light source. In order to suitably progress the photocuring reaction, the wavelength of the ultraviolet rays to be applied in the protective layer forming step is favorably 200 nm or more and 420 nm or less, more favorably 270 nm or more and 420 nm or less, still more favorably 270 nm or more and 400 nm or less, and particularly favorably 365 nm. The light energy of the ultraviolet rays to be applied in the protective layer forming step is favorably 10000 mW·s or more and 100000 mW·s or less, more favorably 60300 mW·s or more and 86400 mW·s or less. When the light energy of ultraviolet rays is 10000 mW·s or more, the photocuring reaction progresses sufficiently and the protective layer can be sufficiently cured. When the light energy is 100000 mW·s or less, it is possible to further suppress decomposition of the hole transporting agent included in the photosensitive layer and improve the sensitivity of the photoreceptor.

The photosensitive layer forming step and the protective layer forming step have been described. The method of producing the photoreceptor according to the first embodiment will be further described below.

The solvent included in the above coating liquid for a single-layer photosensitive layer, coating liquid for a charge generating layer, coating liquid for a charge transporting layer, and coating liquid for a protective layer (hereinafter, collectively referred to as a coating liquid in some cases) is not particularly limited as long as the components included in the coating liquid can be dissolved or dispersed. Examples of the solvent include an alcohol (more specifically, methanol, ethanol, isopropanol, butanol, and the like), an aliphatic hydrocarbon (more specifically, n-hexane, octane, cyclohexane, and the like), an aromatic hydrocarbon (more specifically, benzene, toluene, xylene, and the like), a halogenated hydrocarbon (more specifically, methylene chloride, chloroform, ethylene chloride, dichloromethane, dichloroethane, carbon tetrachloride, chlorobenzene, and the like), ether (more specifically, dioxane, dimethylether, diethylether, tetrahydrofuran, ethylene glycol dimethylether, propylene glycol monomethylether, diethylene glycol dimethylether, and the like), a ketone (more specifically, acetone, methyl ethyl ketone, 2-butanone, cyclohexanone, and the like), ester (more specifically, ethyl acetate, methyl acetate, and the like), dimethylformaldehyde, dimethylformamide, and dimethylsulfoxide.

The coating liquid is prepared by mixing the respective components and dissolving or dispersing them in a solvent. For mixing, for example, a bead mill, a ball mill, a roll mill, a paint shaker, or an ultrasonic disperser can be used.

The method of applying the coating liquid is not particularly limited as long as the coating liquid can be uniformly applied. Examples of the application method include a dip coating method, a spray coating method, a bead coating method, a blade coating method, and a roller coating method.

Examples of the method of removing at least part of the solvent included in the above coating liquid for a single-layer photosensitive layer, coating liquid for a charge generating layer, and coating liquid for a charge transporting layer include heating, reduction of pressure, and a combination of heating and reduction of pressure. More specifically, a method of performing heat treatment (hot air drying) using a high-temperature dryer or a reduced-pressure dryer may be used. The temperature of the heat treatment is, for example, 40° C. or more and 150° C. or less. The time of the heat treatment is, for example, 3 minutes or more and 150 minutes or less.

The method of producing the photoreceptor according to the first embodiment may further include, as necessary, an intermediate layer forming step of forming an intermediate layer on the conductive substrate. Note that the intermediate layer forming step only needs to be performed by appropriately selecting a known method.

### Second Embodiment: Image Forming Apparatus

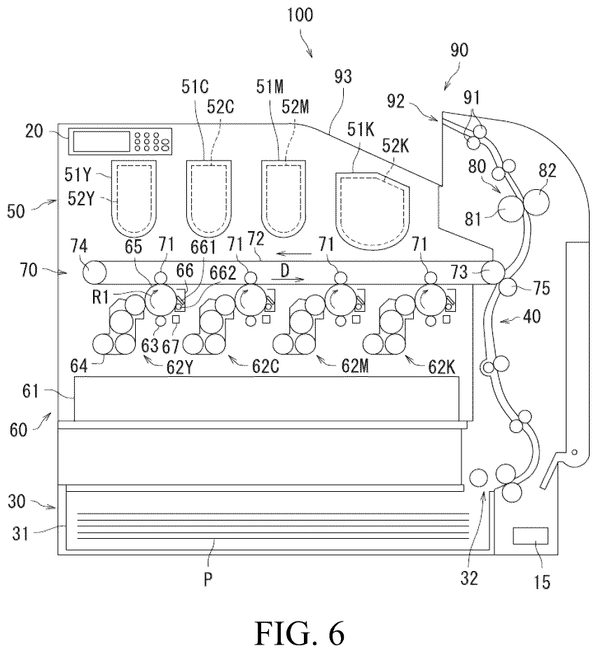

Next, an image forming apparatus 100 that is an example of an image forming apparatus according to a second embodiment of the present disclosure will be described with reference to FIG. 6. FIG. 6 is a diagram showing an example of a configuration of the image forming apparatus 100. The image forming apparatus 100 is, for example, a tandem-type color printer.

As shown in FIG. 6, the image forming apparatus 100 includes a control unit 15, an operation unit 20, a paper feed unit 30, a conveying unit 40, a toner supply unit 50, an image forming unit 60, a transfer device 70, a fixing device 80, and an output unit 90.

The control unit 15 controls the operation of the respective units of the image forming apparatus 100. The control unit 15 includes a processor (not shown) and a storage unit (not shown). The processor includes, for example, a central processing unit (CPU). The storage unit may include a memory such as a semiconductor memory and may include a hard disk drive (HDD). The processor executes a control program to control the operation of the image forming apparatus 100. The storage unit stores the control program.

The operation unit 20 accepts an instruction from a user. The operation unit 20 transmits, upon accepting an instruction from a user, a signal indicating the instruction from a user to the control unit 15. As a result, an image forming operation by the image forming apparatus 100 is started.

The paper feed unit 30 includes a paper feed cassette 31 and a paper feed roller group 32. The paper feed cassette 31 is capable of housing a plurality of recording media P (e.g., sheets of paper). The paper feed roller group 32 feeds the recording media P housed in the paper feed cassette 31 to the conveying unit 40 one sheet at a time.

The conveying unit 40 includes a roller and a guide member. The conveying unit 40 extends from the paper feed unit 30 to the output unit 90. The conveying unit 40 conveys the recording medium P from the paper feed unit 30 to the output unit 90 through the image forming unit 60 and the fixing device 80.

The toner supply unit 50 supplies a toner to the image forming unit 60. The toner supply unit 50 includes a first mounting portion 51Y, a second mounting portion 51C, a third mounting portion 51M, and a fourth mounting portion 51K.

A first toner container 52Y is mounted on the first mounting portion 51Y. Similarly, a second toner container 52C, a third toner container 52M, and a fourth toner container 52K are respectively mounted on the second mounting portion 51C, the third mounting portion 51M, and the fourth mounting portion 51K.

A toner is housed in each of the first toner container 52Y, the second toner container 52C, the third toner container 52M, and the fourth toner container 52K. In the second embodiment, a yellow toner is housed in the first toner container 52Y. A cyan toner is housed in the second toner container 52C. A magenta toner is housed in the third toner container 52M. A black toner is housed in the fourth toner container 52K.

The image forming unit 60 includes an exposure device 61, a first image formation unit 62Y, a second image formation unit 62C, a third image formation unit 62M, and a fourth image formation unit 62K.

Each of the first image formation unit 62Y to the fourth image formation unit 62K includes a charging device 63, a development device 64, an image carrier 65, a cleaning device 66, and a static elimination device 67.

Note that regarding the configurations of the first image formation unit 62Y to the fourth image formation unit 62K, only the type of toner to be supplied from the toner supply unit 50 differs and the other configurations are the same. For this reason, in FIG. 6, the configuration of each of the second image formation unit 62C to the fourth image formation unit 62K is shown with the reference symbol omitted.

The image carrier 65 is the photoreceptor according to the first embodiment (more specifically, the single-layer photoreceptor 1 and the stacked photoreceptor 10). As described in the first embodiment, the photoreceptor according to the first embodiment has excellent sensitivity characteristics, charging characteristics, and wear resistance and is capable of suppressing the occurrence of image deletion of a formed image. Therefore, the image forming apparatus 100 according to the second embodiment has excellent sensitivity characteristics, charging characteristics, and wear resistance and is capable of suppressing the occurrence of image deletion of a formed image.

In the second embodiment, the image carrier 65 rotates in the direction indicated by an arrow R1 in FIG. 6 (clockwise direction in FIG. 6). The charging device 63, the development device 64, the cleaning device 66, and the static elimination device 67 are disposed along the circumferential surface of the image carrier 65 in the order described from the upstream side in the rotation direction of the image carrier 65.

The charging device 63 charges the surface (circumferential surface) of the image carrier 65. The charging device 63 uniformly charges the image carrier 65 to predetermined polarity by electric discharge. The charging device 63 is, for example, a charging roller.

The exposure device 61 exposes the charged surface of the image carrier 65. In detail, the exposure device 61 applies laser light to the charged surface of the image carrier 65. In this way, an electrostatic latent image is formed on the surface of the image carrier 65.

A toner is supplied from the toner supply unit 50 to the development device 64. The development device 64 supplies the toner supplied from the toner supply unit 50 to the surface of the image carrier 65. As a result, the electrostatic latent image formed on the surface of the image carrier 65 is developed as a toner image.

In the second embodiment, the development device 64 of the first image formation unit 62Y is connected to the first toner container 52Y. For this reason, a yellow toner is supplied to the development device 64 of the first image formation unit 62Y. Therefore, a yellow toner image is formed on the surface of the image carrier 65 of the first image formation unit 62Y.

Similarly, the development device 64 of the second image formation unit 62C, the development device 64 of the third image formation unit 62M, and the development device 64 of the fourth image formation unit 62K are respectively connected to the second toner container 52C, the third toner container 52M, and the fourth toner container 52K. For this reason, a cyan toner, a magenta toner, and a black toner are respectively supplied to the development device 64 of the second image formation unit 62C, the development device 64 of the third image formation unit 62M, and the development device 64 of the fourth image formation unit 62K. Therefore, a cyan toner image, a magenta toner image, and a black toner image are respectively formed on the surface of the image carrier 65 of the second image formation unit 62C, the surface of the image carrier 65 of the third image formation unit 62M, and the surface of the image carrier 65 of the fourth image formation unit 62K.

The cleaning device 66 includes a cleaning member 661 and a rubbing roller 662. After transfer by a primary transfer roller 71 described below, the cleaning member 661 is pressed against the surface of the image carrier 65 to collect the toner adhering to the surface of the image carrier 65. The cleaning member 661 is, for example, a cleaning blade. The rubbing roller 662 rubs the surface of the image carrier 65 to polish the surface of the image carrier 65.

The static elimination device 67 applies static elimination light to the surface of the image carrier 65 to eliminate static electricity on the surface of the image carrier 65.

The transfer device 70 transfers a toner image from the image carrier 65 to the recording medium P that is a to-be-transferred body. In detail, the transfer device 70 transfers each toner image formed on the surface of each image carrier 65 of the first image formation unit 62Y to the fourth image formation unit 62K onto the recording medium P in a superimposed manner. In the second embodiment, the transfer device 70 transfers each toner image onto the recording medium P in a superimposed manner using a secondary transfer method (intermediate transfer method). The transfer device 70 includes four primary transfer rollers 71, an intermediate transfer belt 72, a drive roller 73, a driven roller 74, and a secondary transfer roller 75.

The intermediate transfer belt 72 is an endless belt stretched over the four primary transfer rollers 71, the drive roller 73, and the driven roller 74. The intermediate transfer belt 72 is driven in accordance with rotation of the drive roller 73. The intermediate transfer belt 72 rotates counterclockwise in FIG. 6. The driven roller 74 is driven to rotate in accordance with the drive of the intermediate transfer belt 72.

The first image formation unit 62Y to the fourth image formation unit 62K are disposed to face the lower surface of the intermediate transfer belt 72. In the second embodiment, the first image formation unit 62Y to the fourth image formation unit 62K are disposed in the order of the first image formation unit 62Y to the fourth image formation unit 62K from the upstream side to the downstream side in a drive direction D of the lower surface of the intermediate transfer belt 72.

Each primary transfer roller 71 is disposed to face the corresponding image carrier 65 via the intermediate transfer belt 72 and is pressed toward the image carrier 65. For this reason, the toner image formed on the surface of each image carrier 65 by each primary transfer roller 71 is sequentially transferred onto the intermediate transfer belt 72. In the second embodiment, a yellow toner image, a cyan toner image, a magenta toner image, and a black toner image are transferred onto the intermediate transfer belt 72 in this order in a superimposed manner. Hereinafter, the toner image obtained by superimposing a yellow toner image, a cyan toner image, a magenta toner image, and a black toner image will be referred to as a “stacked toner image” in some cases.

The secondary transfer roller 75 is disposed to face the drive roller 73 via the intermediate transfer belt 72. The secondary transfer roller 75 is pressed toward the drive roller 73. This forms a transfer nip between the secondary transfer roller 75 and the drive roller 73. When the recording medium P passes through the transfer nip, the stacked toner image on the intermediate transfer belt 72 is transferred onto the recording medium P by the secondary transfer roller 75. In the second embodiment, a yellow toner image, a cyan toner image, a magenta toner image, and a black toner image are transferred onto the recording medium P in this order as the top layer to the bottom layer. The recording medium P onto which the stacked toner image has been transferred is conveyed toward the fixing device 80 by the conveying unit 40.

The fixing device 80 includes a heating member 81 and a pressure member 82. The heating member 81 and the pressure member 82 are disposed to face each other to form a fixing nip. The recording medium P conveyed from the image forming unit 60 is pressurized while being heated at a predetermined fixing temperature by passing through the fixing nip. As a result, the stacked toner image is fixed to the recording medium P. The recording medium P is conveyed from the fixing device 80 to the output unit 90 by the conveying unit 40.

The output unit 90 includes an output roller pair 91 and an output tray 93. The output roller pair 91 conveys the recording medium P to the output tray 93 via an output port 92. The output port 92 is formed in the upper part of the image forming apparatus 100.

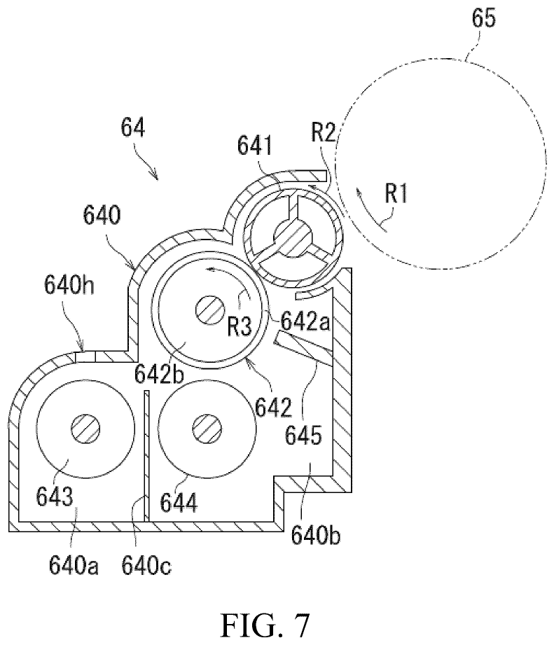

Next, a configuration of the development device 64 will be described in detail with reference to FIG. 7. FIG. 7 is a diagram showing a configuration of the development device 64. In detail, FIG. 7 shows the development device 64 of the first image formation unit 62Y. Note that in FIG. 7, the image carrier 65 is illustrated by a two-dot chain line for ease of understanding. In the second embodiment, the development device 64 adopts a two-component development method using a two-component developer and a touch-down development method.

As described above with reference to FIG. 6, a development container 640 of the development device 64 is connected to the first toner container 52Y. Therefore, a yellow toner is supplied to the development container 640 of the development device 64 via a toner supply port 640h.

As shown in FIG. 7, the development device 64 includes, inside the development container 640, a development roller 641, a magnetic roller 642, a first stirring screw 643, a second stirring screw 644, and a blade 645. In detail, the development roller 641 is disposed to face the magnetic roller 642. The magnetic roller 642 is disposed to face the second stirring screw 644. The blade 645 is disposed to face the magnetic roller 642.

The development container 640 is divided into a first stirring chamber 640a and a second stirring chamber 640b by a partition wall 640c. The partition wall 640c extends in the axial direction of the development roller 641. The first stirring chamber 640a and the second stirring chamber 640b communicate with each other on the outside at both ends of the partition wall 640c in the longitudinal direction.

The first stirring screw 643 is disposed in the first stirring chamber 640a. A carrier that is a magnetic material is housed in the first stirring chamber 640a. A toner that is a non-magnetic material is supplied to the first stirring chamber 640a via the toner supply port 640h. In the example shown in FIG. 7, a yellow toner is supplied to the first stirring chamber 640a

The second stirring screw 644 is disposed in the second stirring chamber 640b. A carrier that is a magnetic material is housed in the second stirring chamber 640b.

The yellow toner is stirred with the carrier by the first stirring screw 643 and the second stirring screw 644. As a result, a two-component developer that includes a carrier and a yellow toner is formed. In this way, the two-component developer is housed in the development container 640 (more specifically, the first stirring chamber 640a and the second stirring chamber 640b).

The first stirring screw 643 and the second stirring screw 644 stir the two-component developer while circulating it between the first stirring chamber 640a and the second stirring chamber 640b. As a result, the toner is charged to predetermined polarity by friction with the carrier.

Note that in the case where the image carrier 65 is the single-layer photoreceptor 1, the surface of the image carrier 65 and the toner are charged to, for example, positive polarity. In the case where the image carrier 65 is the stacked photoreceptor 10, the surface of the image carrier 65 and the toner are charged to, for example, negative polarity.

The magnetic roller 642 includes a non-magnetic rotating sleeve 642a and a magnet body 642b. The magnet body 642b is fixed to and disposed in the rotating sleeve 642a. The magnet body 642b includes a plurality of magnetic poles. The two-component developer is attracted to the magnetic roller 642 by the magnetic force of the magnet body 642b. As a result, a magnetic brush is formed on the surface of the magnetic roller 642.

The blade 645 is disposed on the upstream side in the rotation direction of the magnetic roller 642 than the position where the magnetic roller 642 and the development roller 641 face each other. In the second embodiment, the magnetic roller 642 rotates in the direction indicated by an arrow R3 in FIG. 7 (counterclockwise direction in FIG. 7). The magnetic roller 642 rotates to convey the magnetic brush to the position facing the blade 645. The blade 645 is disposed such that a gap is formed between the blade 645 and the magnetic roller 642. The blade 645 is formed of a magnetic material. Therefore, the thickness of the magnetic brush is regulated by the magnetic force of the blade 645.

After the thickness of the magnetic brush on the magnetic roller 642 is regulated, a predetermined voltage is applied to the magnetic roller 642 and the development roller 641. When the predetermined voltage is applied to obtain a predetermined potential difference between the magnetic roller 642 and the development roller 641, the yellow toner included in the two-component developer migrates to the development roller 641. As a result, the toner thin layer including the yellow toner is formed on the surface of the development roller 641.

The development roller 641 rotates in a direction indicated by an arrow R2 in FIG. 7 (counterclockwise direction in FIG. 7). This causes the toner thin layer formed on the surface of the development roller 641 to be conveyed to the position facing the image carrier 65 and adhere to the image carrier 65. In this way, the development device 64 supplies the toner charged due to the friction with the carrier to the surface of the image carrier 65.

The development device 64 of the first image formation unit 62Y has been described above with reference to FIG. 7. Regarding the configuration of the development device 64 of each of the first image formation unit 62Y to the fourth image formation unit 62K, only the type of toner to be supplied from the toner supply unit 50 differs and the other configurations are the same. For this reason, description of the configuration of the development device 64 of each of the second image formation unit 62C to the fourth image formation unit 62K is omitted.

The image forming apparatus 100 that is an example of the image forming apparatus according to the second embodiment has been described above with reference to FIG. 6 and FIG. 7. However, the image forming apparatus according to the second embodiment is not limited to the image forming apparatus 100. For example, the image forming apparatus may be a monochrome image forming apparatus. In this case, the image forming apparatus only needs to include one image formation unit. The image forming apparatus may adopt a rotary method. The charging device may be a charging device other than the charging roller (e.g., a scorotron charger, a charging brush, or a corotron charger). The image forming apparatus may adopt a one-component development method using a one-component developer. The image forming apparatus may adopt a development method other than the touch-down development method (e.g., a development method in which no development roller is provided and a magnetic roller serves also as a development roller). The image forming apparatus may adopt a direct transfer method. In the case where the image forming apparatus adopts a direct transfer method, a toner image is directly transferred to a recording medium from an image carrier while the image carrier is in contact with the recording medium. The image forming apparatus does not necessarily need to include a cleaning device. The image forming apparatus does not necessarily need to include a static elimination device. The image forming apparatus according to the second embodiment has been described above.

### Third Embodiment: Process Cartridge

Next, a process cartridge according to a third embodiment of the present disclosure will be described with continued reference to FIG. 6. The process cartridge according to the third embodiment corresponds to each of the first image formation unit 62Y to the fourth image formation unit 62K. The process cartridge includes the image carrier 65, and the image carrier 65 is the photoreceptor according to the first embodiment (more specifically, the single-layer photoreceptor 1 and the stacked photoreceptor 10). As described in the first embodiment, the photoreceptor according to the first embodiment has excellent sensitivity characteristics, charging characteristics, and wear resistance and is capable of suppressing the occurrence of image deletion of a formed image. Therefore, the process cartridge according to the third embodiment, which includes the photoreceptor according to the first embodiment, has excellent sensitivity characteristics, charging characteristics, and wear resistance and is capable of suppressing the occurrence of image deletion of a formed image.

The process cartridge may further include at least one (e.g., 1 or more and 7 or less) selected from the group consisting of the charging device 63, the exposure device 61, the development device 64, the transfer device 70 (particularly, the primary transfer roller 71), the cleaning member 661, the rubbing roller 662, and the static elimination device 67, in addition to the image carrier 65. The process cartridge is designed to be attachable/detachable to/from the image forming apparatus 100. For this reason, the process cartridge is easy to handle, and can be easily and quickly replaced together with the image carrier 65 in the case where the sensitivity characteristics or the like of the image carrier 65 deteriorate. The process cartridge according to the third embodiment has been described above with reference to FIG. 6.

### [Substituent Group]

The substituent group used in the present specification will be described below. Examples of the halogen atom (halogen group) include a fluorine atom (fluoro group), a chlorine atom (chloro group), a bromine atom (bromo group), and an iodine atom (iodo group).

Unless otherwise specified, each of the alkyl group having 1 or more and 18 or less carbon atoms, the alkyl group having 10 or more and 18 or less carbon atoms, the alkyl group having 15 or more and 18 or less carbon atoms, the alkyl group having 18 carbon atoms, the alkyl group having 1 or more and 8 or less carbon atoms, the alkyl group having 1 or more and 6 or less carbon atoms, the alkyl group having 1 or more and 5 or less carbon atoms, the alkyl group having 1 or more and 4 or less carbon atoms, and the alkyl group having 1 or more and 3 or less carbon atoms is linear or branched chain and unsubstituted. Examples of the alkyl group having 1 or more and 18 or less carbon atoms include a methyl group, an ethyl group, an n-propyl group, an isopropyl group, an n-butyl group, a sec-butyl group, a tert-butyl group, an n-pentyl group, a 1-methylbutyl group, a 2-methylbutyl group, a 3-methylbutyl group, a 1-ethylpropyl group, a 2-ethylpropyl group, a 1,1-dimethylpropyl group, a 1,2-dimethylpropyl group, a 2,2-dimethylpropyl group, an n-hexyl group, a 1-methylpentyl group, a 2-methylpentyl group, a 3-methylpentyl group, a 4-methylpentyl group, a 1,1-dimethylbutyl group, a 1,2-dimethylbutyl group, a 1,3-dimethylbutyl group, a 2,2-dimethylbutyl group, a 2,3-dimethylbutyl group, a 3,3-dimethylbutyl group, a 1,1,2-trimethylpropyl group, a 1,2,2-trimethylpropyl group, a 1-ethylbutyl group, a 2-ethylbutyl group, a 3-ethylbutyl group, linear and branched chain heptyl groups, linear and branched chain octyl groups, linear and branched chain nonyl groups, linear and branched chain decyl groups, linear and branched chain undecyl groups, linear and branched chain dodecyl groups, linear and branched chain tridecyl groups, linear and branched chain tetradecyl groups, linear and branched chain pentadecyl groups, linear and branched chain hexadecyl groups, linear and branched chain heptadecyl groups, and linear and branched chain octadecyl groups. Examples of the alkyl group having 10 or more and 18 or less carbon atoms, the alkyl group having 15 or more and 18 or less carbon atoms, the alkyl group having 18 carbon atoms, the alkyl group having 1 or more and 8 or less carbon atoms, the alkyl group having 1 or more and 6 or less carbon atoms, the alkyl group having 1 or more and 5 or less carbon atoms, the alkyl group having 1 or more and 4 or less carbon atoms, and the alkyl group having 1 or more and 3 or less carbon atoms are groups having the corresponding number of carbon atoms, of the groups mentioned as the examples of the alkyl group having 1 or more and 18 or less carbon atoms.

Unless otherwise specified, the alkoxy group having 1 or more and 6 or less carbon atoms is linear or branched chain and unsubstituted. Examples of the alkoxy group having 1 or more and 6 or less carbon atoms include a methoxy group, an ethoxy group, an n-propoxy group, an isopropoxy group, an n-butoxy group, a sec-butoxy group, a tert-butoxy group, an n-pentoxy group, a 1-methylbutoxy group, a 2-methylbutoxy group, a 3-methylbutoxy group, a 1-ethylpropoxy group, a 2-ethylpropoxy group, a 1,1-dimethylpropoxy group, a 1,2-dimethylpropoxy group, a 2,2-dimethylpropoxy group, an n-hexyloxy group, a 1-methylpentyloxy group, a 2-methylpentyloxy group, a 3-methylpentyloxy group, a 4-methylpentyloxy group, a 1,1-dimethylbutoxy group, a 1,2-dimethylbutoxy group, a 1,3-dimethylbutoxy group, a 2,2-dimethylbutoxy group, a 2,3-dimethylbutoxy group, a 3,3-dimethylbutoxy group, a 1,1,2-trimethylpropoxy group, a 1,2,2-trimethylpropoxy group, a 1-ethylbutoxy group, a 2-ethylbutoxy group, and a 3-ethylbutoxy group.

Unless otherwise specified, each of the aryl group having 6 or more and 14 or less carbon atoms and the aryl group having 6 or more and 10 or less carbon atoms is unsubstituted. Examples of the aryl group having 6 or more and 14 or less carbon atoms include a phenyl group, a naphthyl group, an indacenyl group, a biphenylenyl group, an acenaphthylenyl group, an anthryl group, and a phenanthryl group. Examples of the aryl group having 6 or more and 10 or less carbon atoms are groups having the corresponding number of carbon atoms, of the groups mentioned as the examples of the aryl group having 6 or more and 14 or less carbon atoms.

Unless otherwise specified, the alkenyl group having 2 or more and 6 or less carbon atoms is linear or branched chain and unsubstituted. The alkenyl group having 2 or more and 6 or less carbon atoms has 1 or more and 3 or less double bonds. Examples of the alkenyl group having 2 or more and 6 or less carbon atoms include an ethenyl group, a propenyl group, a butenyl group, a butadienyl group, a pentenyl group, a hexenyl group, a hexadienyl group, and a hexatrienyl group.

Unless otherwise specified, each of the alkanediyl group having 1 or more and 6 or less carbon atoms, the alkanediyl group having 2 or more and 4 or less carbon atoms, and the alkanediyl group having 3 carbon atoms is linear or branched chain and unsubstituted. Examples of the alkanediyl group having 1 or more and 6 or less carbon atoms include a methanediyl group (methylene group), an ethanediyl group, an n-propanediyl group, an isopropanediyl group, an n-butanediyl group, a sec-butanediyl group, a tert-butanediyl group, an n-pentanediyl group, a 1-methylbutanediyl group, a 2-methylbutanediyl group, a 3-methylbutanediyl group, a 1-ethylpropanediyl group, a 2-ethylpropanediyl group, a 1,1-dimethylpropanediyl group, a 1,2-dimethylpropanediyl group, a 2,2-dimethylpropanediyl group, an n-hexanediyl group, a 1-methylpentanediyl group, a 2-methylpentanediyl group, a 3-methylpentanediyl group, a 4-methylpentanediyl group, a 1,1-dimethylbutanediyl group, a 1,2-dimethylbutanediyl group, a 1,3-dimethylbutanediyl group, a 2,2-dimethylbutanediyl group, a 2,3-dimethylbutanediyl group, a 3,3-dimethylbutanediyl group, a 1,1,2-trimethylpropanediyl group, a 1,2,2-trimethylpropanediyl group, a 1-ethylbutanediyl group, a 2-ethylbutanediyl group, and a 3-ethylbutanediyl group. Examples of the alkanediyl group having 2 or more and 4 or less carbon atoms and the alkanediyl group having 3 carbon atoms are groups having the corresponding number of carbon atoms, of the groups mentioned as the examples of the alkanediyl group having 1 or more and 6 or less carbon atoms. The substituent group used in the present specification has been described above.

### EXAMPLES

Although the present disclosure will be further specifically described below using Examples, the present disclosure is not limited to the scope of the Examples.

### [First Particle]

The following ones were prepared as first particles to be included in the protective layer.
First particle (S-1): phosphorus-doped tin oxide (“SP-2” manufactured by Mitsubishi Materials Electronic Chemicals Co., Ltd., a BET specific surface area of 105±25 m²/g)
First particle (S-2): tin oxide (“S-1” manufactured by Mitsubishi Materials Electronic Chemicals Co., Ltd., undoped tin oxide, a BET specific surface area of 55±5 m²/g)
First particle (S-3): tin oxide (“S-2000” manufactured by Mitsubishi Materials Electronic Chemicals Co., Ltd., undoped tin oxide, a BET specific surface area of 52.5±7.5 m²/g)
First particle (S-4): antimony-doped tin oxide (“T-1” manufactured by Mitsubishi Materials Electronic Chemicals Co., Ltd., a BET specific surface area of 77.5±7.5 m²/g, a number average primary particle size of 200 nm)
First particle (S-5): zinc oxide (“NanoTek ZnO” manufactured by CIK-Nano Tek, a number average primary particle size of 65.9 nm)
First particle (S-6): titanium oxide (“MT-500B” manufactured by TAYCA Co., Ltd., a number average primary particle size of 40 nm)

### [Second Particle]

The following ones were prepared as second particles to be included in the protective layer.
Second particle (A-1): alumina (“Nanotek Al₂O₃” manufactured by CIK-Nano Tek, a BET specific surface area of 55 m²/g, a number average primary particle size of 31 nm)
Second particle (A-2): silica (“Nanotek SiO₂” manufactured by CIK-Nano Tek, a BET specific surface area of 110 m²/g, a number average primary particle size of 11 nm)
Second particle (A-3): silicone (“MSP-N050” manufactured by NIKKO RICA CORPORATION, a number average primary particle size of 500 nm)

### [Multifunctional Group Monomer]

The following one was used as a multifunctional group monomer.
Multifunctional group monomer (B-1):“A-DPH” manufactured by SHIN-NAKAMURA CHEMICAL CO, LTD. (mixture of the compounds represented by the formulae (EA-3) and (EA-4) described in the first embodiment, a hydroxyl value of 10 mgKOH/g, the compound represented by the formula (EA-3) having the number of polymerizable functional groups of 5, the compound represented by the formula (EA-4) having the number of polymerizable functional groups of 6)

### [Monofunctional Group Monomer]

The following one was used as a monofunctional group monomer.
Monofunctional group monomer (C-3): “Viscoat 8F” manufactured by OSAKA ORGANIC CHEMICAL INDUSTRY LTD. (compound represented by the formula (C-3) described in the first embodiment, the number of polymerizable functional groups of 1)

### [Production of Stacked Photoreceptor]

Stacked photoreceptors (P-A1) to (P-A20) and (P-B1) to (P-B11) were produced by the following method. The configurations of these stacked photoreceptors are shown in Table 1 to Table 2.

TABLE 1

| | | Protective layer | | | | | | Electron transporting layer | |
|---|---|---|---|---|---|---|---|---|---|
| | | | | | | | Total | HTM | |
| | | First particle | | Second particle | | | content | | Content |
| | Stacked | | Amount | | Amount | First/ | ratio | Amount | ratio |
| | photoreceptor | Type | [parts] | Type | [parts] | second | [mass %] | [parts] | [mass %] |
| Ex 1 | P-A1 | S-1 | 8 | A-1 | 5 | 1.6 | 11.5 | 90 | 47.4 |
| Ex 2 | P-A2 | S-1 | 2 | A-1 | 1 | 2.0 | 2.9 | 90 | 47.4 |
| Ex 3 | P-A3 | S-1 | 5 | A-1 | 1 | 5.0 | 5.7 | 90 | 47.4 |
| Ex 4 | P-A4 | S-1 | 10 | A-1 | 1 | 10.0 | 9.9 | 90 | 47.4 |
| Ex 5 | P-A5 | S-1 | 13 | A-1 | 1 | 13.0 | 12.3 | 90 | 47.4 |
| Ex 6 | P-A6 | S-1 | 8 | A-1 | 6 | 1.3 | 12.3 | 90 | 47.4 |
| Ex 7 | P-A7 | S-1 | 8 | A-1 | 5 | 1.6 | 11.5 | 70 | 41.2 |
| Ex 8 | P-A8 | S-1 | 8 | A-1 | 5 | 1.6 | 11.5 | 110 | 52.4 |
| Ex 9 | P-A9 | S-2 | 2 | A-1 | 1 | 2.0 | 2.9 | 90 | 47.4 |
| Ex 10 | P-A10 | S-2 | 13 | A-1 | 1 | 13.0 | 12.3 | 90 | 47.4 |
| Ex 11 | P-A11 | S-3 | 2 | A-1 | 1 | 2.0 | 2.9 | 90 | 47.4 |
| Ex 12 | P-A12 | S-3 | 13 | A-1 | 1 | 13.0 | 12.3 | 90 | 47.4 |
| Ex 13 | P-A13 | S-4 | 2 | A-1 | 1 | 2.0 | 2.9 | 90 | 47.4 |
| Ex 14 | P-A14 | S-4 | 13 | A-1 | 1 | 13.0 | 12.3 | 90 | 47.4 |
| Ex 15 | P-A15 | S-1 | 10 | A-1 | 8 | 1.3 | 15.3 | 90 | 47.4 |
| Ex 16 | P-A16 | S-1 | 15 | A-1 | 1 | 15.0 | 13.8 | 90 | 47.4 |
| Ex 17 | P-A17 | S-1 | 15 | A-1 | 3 | 5.0 | 15.3 | 90 | 47.4 |
| Ex 18 | P-A18 | S-1 | 10 | A-1 | 8 | 1.3 | 15.3 | 90 | 47.4 |
| Ex 19 | P-A19 | S-1 | 15 | A-1 | 1 | 15.0 | 13.8 | 90 | 47.4 |
| Ex 20 | P-A20 | S-1 | 15 | A-1 | 3 | 5.0 | 15.3 | 90 | 47.4 |

TABLE 2

| | | Protective layer | | | | | | Electron transporting layer | |
|---|---|---|---|---|---|---|---|---|---|
| | | | | | | | Total | HTM | |
| | | First particle | | Second particle | | | content | | Content |
| | Stacked | | Amount | | Amount | First/ | ratio | Amount | ratio |
| | photoreceptor | Type | [parts] | Type | [parts] | second | [mass %] | [parts] | [mass %] |
| Comp 1 | P-B1 | S-1 | 5 | A-1 | 5 | 1.0 | 9.1 | 90 | 47.4 |
| Comp 2 | P-B2 | — | — | — | — | — | — | 90 | 47.4 |
| Comp 3 | P-B3 | — | — | A-1 | 8 | — | 7.4 | 90 | 47.4 |
| Comp 4 | P-B4 | S-1 | 5 | A-1 | 8 | 0.6 | 11.5 | 90 | 47.4 |
| Comp 5 | P-B5 | S-1 | 8 | A-1 | 8 | 1.0 | 13.8 | 90 | 47.4 |
| Comp 6 | P-B6 | S-1 | 15 | — | — | — | 13.0 | 90 | 47.4 |
| Comp 7 | P-B7 | S-5 | 8 | A-1 | 5 | 1.6 | 11.5 | 90 | 47.4 |
| Comp 8 | P-B8 | S-6 | 8 | A-1 | 5 | 1.6 | 11.5 | 90 | 47.4 |
| Comp 9 | P-B9 | S-1 | 8 | A-2 | 5 | 1.6 | 11.5 | 90 | 47.4 |
| Comp 10 | P-B10 | S-1 | 8 | A-3 | 5 | 1.6 | 11.5 | 90 | 47.4 |

| | | | | |
|---|---|---|---|---|
| Comp 11 | P-B11 | No protective layer | 90 | 47.4 |

The terms in Table 1 to Table 2 are as follows.

Ex: Example

Comp: Comparative Example

Parts: parts by mass of

First/second: ratio of the content of the first particle to the content of the second particle

Total content ratio in the column of the protective layer:total content ratio (unit:mass %) of the first particle and the second particle to the mass of the protective layer
: no corresponding component is included or no corresponding value

HTM: hole transporting agent

Content ratio in the column of HTM:content ratio (unit:mass %) of the hole transporting agent to the mass of the charge transporting layer

### <Production of Stacked Photoreceptor (P-A1)>

### (Formation of Intermediate Layer)

2 parts by mass of titanium oxide, 1 part by mass of a polyamide resin, 10 parts by mass of methanol, 1 part by mass of butanol, and 1 part by mass of toluene were mixed for 5 hours using a bead mill to obtain a mixed solution a. As the titanium oxide, a prototype “SMT-A” manufactured by TAYCA Co., Ltd. (a number average primary particle size of 10 nm, obtained by performing primary surface treatment on titanium oxide using alumina and silica and performing secondary surface treatment on the titanium oxide subjected to the primary surface treatment using methylhydrogenpolysiloxane) was used. As the polyamide resin, “Amilan (registered trademark) CM8000” manufactured by TORAY INDUSTRIES, INC. (quaternary copolymerized polyamide resin of polyamide 6, polyamide 12, polyamide 66, and polyamide 610) was used. The obtained mixed solution a was filtered with a filter with an opening of 5 μm to obtain a coating liquid for an intermediate layer. Subsequently, the coating liquid for an intermediate layer was applied onto the surface of the conductive substrate by a dip coating method. As the conductive substrate, a drum-shaped support formed of aluminum was used. Subsequently, the applied coating liquid for an intermediate layer was dried at 130° C. for 30 minutes to form an intermediate layer (film thickness: 0.5 μm) on the conductive substrate.

### (Formation of Charge Generating Layer)

1.5 parts by mass of a Y-type titanyl phthalocyanine as a charge generating agent, 1 part by mass of a polyvinylacetal resin (“S-LEC BX-5” manufactured by SEKISUI CHEMICAL CO., LTD.) as a base resin, 40 parts by mass of propylene glycol monomethylether, and 40 parts by mass of tetrahydrofuran were mixed using a bead mill for 12 hours to obtain a mixed solution D. The obtained mixed solution D was filtered with a filter with an opening of 3 μm to obtain a coating liquid for a charge generating layer. Subsequently, the coating liquid for a charge generating layer was applied onto the intermediate layer on the conductive substrate by a dip coating method. The applied coating liquid for a charge generating layer was dried at 50° C. for 5 minutes to form a charge generating layer (film thickness: 0.3 μm) on the intermediate layer.

### (Formation of Charge Transporting Layer)

A total of 90 parts by mass of a hole transporting agent (more specifically, 60 parts by mass of a hole transporting agent (HT-2) and 30 parts by mass of a hole transporting agent (HT-3)), 100 parts by mass of a bisphenol Z-type polycarbonate resin, 0.05 parts by mass of a leveling agent, 340 parts by mass of tetrahydrofuran, and 60 parts by mass of toluene were mixed using a roll mill for 24 hours to obtain a coating liquid for a charge transporting layer. As a leveling agent, dimethylsilicone oil (“KF96-50CS” manufactured by Shin-Etsu Chemical Co., Ltd.) was used. Subsequently, the coating liquid for a charge transporting layer was applied onto the charge generating layer by a dip coating method. The applied coating liquid for a charge transporting layer was dried at 120° C. for 40 minutes to form a charge transporting layer (film thickness: 25 μm) on the charge generating layer. The content ratio of the hole transporting agent to the mass of the charge transporting layer was 47.4 mass % (=100×(60+30)/(60+30+100+0.05)).

### (Formation of Protective Layer)

8 parts by mass of a first particle (S-1), 5 parts by mass of a second particle (A-1), 56 parts by mass of a multifunctional group monomer (B-1), 33 parts by mass of a monofunctional group monomer(C-3), 1 part by mass of a leveling agent, 10 parts by mass of a polymerization initiator, and 110 parts by mass of methanol were mixed using a bead mill for 12 hours to obtain a mixed solution c. As a leveling agent, a UV curable fluorosilicone modified acrylic polymer having a vinyl group (“8FS-001” manufactured by TAISEI FINE CHEMICAL CO.,LTD., a double bond equivalent (vinyl group equivalent): 420 g/mol) was used. As a polymerization initiator, a compound represented by the following formula (ST-1) (“OMNIRAD TPO” manufactured by manufactured by IGM Resins B.V.) was used. The obtained mixed solution c was filtered with a filter with an opening of 5 μm to obtain a coating liquid for a protective layer.

Subsequently, the coating liquid for a protective layer was applied onto the charge transporting layer by a dip coating method. Ultraviolet rays having a wavelength of 365 nm were applied from a light-emitting diode light source to the applied coating liquid for a protective layer under the condition of light energy of 86400 mW·s. The application of ultraviolet rays polymerized (photocuring reaction) the multifunctional group monomer, monofunctional group monomer, and leveling agent in the coating liquid for a protective layer to form a photocurable resin. In this way, protective layer (film thickness: 2.0 μm) was formed on the charge transporting layer. The protective layer included the photocurable resin cured by the photocuring reaction, the first particle (S-1), the second particle (A-1), and the polymerization initiator. The total content ratio of the first particle and the second particle to the mass of the protective layer was 11.5 mass % (=100×(8+5)/(8+5+56+33+1+10)).

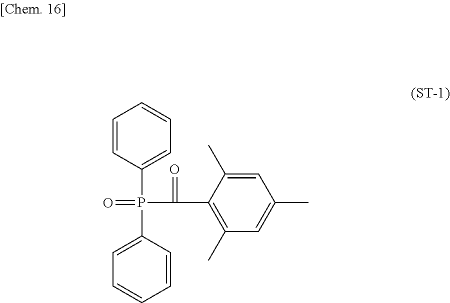 [SMILES: Cc1cc(C)c(C(=O)P(=O)(c2ccccc2)c2ccccc2)c(C)c1]

### <Production of Stacked Photoreceptors (P-A2) to (P-A6), (P-A9) to (P-A20), (P-B1), (P-B4) to (P-B5), and (P-B7) to (P-B10)>

Stacked photoreceptors (P-A2) to (P-A6), (P-A9) to (P-A20), (P-B1), (P-B4) to (P-B5), and (P-B7) to (P-B10) were produced in the same manner as in the production of the stacked photoreceptor (P-A1) except that the first particles shown in Tables 1 to 2 were used in the amounts shown in Tables 1 to 2 and the second particles shown in Tables 1 to 2 were used in the amounts shown in Tables 1 to 2.

### <Production of Stacked Photoreceptor (P-A7)>

A stacked photoreceptor (P-A7) was produced in the same manner as in the production of the stacked photoreceptor (P-A1) except that a total of 90 parts by mass of a hole transporting agent (more specifically, 60 parts by mass of a hole transporting agent (HT-2) and 30 parts by mass of a hole transporting agent (HT-3)) was changed to a total of 70 parts by mass of a hole transporting agent (more specifically, 45 parts by mass of a hole transporting agent (HT-2) and 25 parts by mass of a hole transporting agent(HT-3)).

### <Production of Stacked Photoreceptor (P-A8)>

A stacked photoreceptor (P-A8) was produced in the same manner as in the production of the stacked photoreceptor (P-A1) except that a total of 90 parts by mass of a hole transporting agent (more specifically, 60 parts by mass of a hole transporting agent (HT-2) and 30 parts by mass of a hole transporting agent (HT-3)) was changed to a total of 110 parts by mass of a hole transporting agent (more specifically, 75 parts by mass of a hole transporting agent (HT-2) and 35 parts by mass of a hole transporting agent(HT-3)).

### <Production of Stacked Photoreceptor (P-B2)>

A stacked photoreceptor (P-B2) was produced in the same manner as in the production of the stacked photoreceptor (P-A1) except that the first particle and the second particle were not used.

### <Production of Stacked Photoreceptor (P-B3)>

A stacked photoreceptor (P-B3) was produced in the same manner as in the production of the stacked photoreceptor (P-A1) except that the first particle was not used.

### <Production of Stacked Photoreceptor (P-B6)>

A stacked photoreceptor (P-B6) was produced in the same manner as in the production of the stacked photoreceptor (P-A1) except that the second particle was not used.

### <Production of Stacked Photoreceptor (P-B11)>

A stacked photoreceptor (P-B11) was produced in the same manner as in the production of the stacked photoreceptor (P-A1) except that the above formation of a protective layer was not performed.

### [Evaluation of Stacked Photoreceptor]

The sensitivity characteristics, charging characteristics, wear resistance, and image deletion of each stacked photoreceptor were evaluated by the following method.

### <Sensitivity Characteristics>

The sensitivity characteristics of the photoreceptor were evaluated using a drum sensitivity tester (manufactured by GENTEC) in an environment of a temperature of 23° C. and a relative humidity of 50% RH. The surface of the photoreceptor was charged to −550 V using the drum sensitivity tester. Subsequently, monochromatic light (a wavelength: 780 nm, an exposure amount: 0.87 μJ/cm²) was extracted using a bandpass filter from the light of a halogen lamp and applied to the surface of the photoreceptor. The surface potential of the photoreceptor at the time point when 50 ms elapsed since the end of application of monochromatic light was measured. The measured surface potential was used as the post-exposure potential VL (unit: −V) of the photoreceptor. The post-exposure potential VL is shown in Table 3 to Table 4. The criteria for judging the sensitivity characteristics of the photoreceptor are shown below.

### (Criteria for Sensitivity Characteristics)

Good: the absolute value of VL is 150 V or less.

Poor: the absolute value of VL exceeds 150 V.

### <Charging Characteristics>

The charging characteristics of the photoreceptor were evaluated using a drum sensitivity tester (manufactured by GENTEC) in an environment of a temperature of 23° C. and a relative humidity of 50% RH. As a charging device of the drum sensitivity tester, a corotron charger was used. The measurement conditions for the drum sensitivity tester were set to a flowing current Ipc from the corotron charger to the photoreceptor of −5 μA, the circumferential speed of the photoreceptor of 125 rpm, and performing elimination of static electricity. The surface of the photoreceptor was charged using the drum sensitivity tester while causing the photoreceptor to rotate, and the surface potential of the photoreceptor at the time point when the photoreceptor rotated 10 times was measured. The measured surface potential was used as a charging potential V0 (unit: −V) of the photoreceptor. The charging potential V0 is shown in Table 3 to Table 4. The criteria for judging the charging characteristics of the photoreceptor are shown below.

### (Criteria for Charging Characteristics)

Good: the absolute value of V0 is 450 V or more.

Poor: the absolute value of V0 is less than 450 V.

### <Wear Resistance>

As an evaluation device of wear resistance of the stacked photoreceptor, a color printer (“C711dn” manufactured by Oki Electric Industry Co., Ltd.) was used. A development container and a toner cartridge of the evaluation device were respectively filled with a cyan developer and a cyan toner. First, a film thickness T1 of the photosensitive layer of the photoreceptor was measured. Subsequently, the photoreceptor was mounted on the evaluation device. Subsequently, an image I (pattern image with a coverage rate of 1%) was printed on 10,000 pieces of paper using the evaluation device in a normal temperature and normal humidity environment of a temperature of 23° and a relative humidity of 50% RH. Subsequently, the image I was printed on 10,000 pieces of paper using the evaluation device in a high-temperature and high-humidity environment of a temperature of 32° C. and a relative humidity of 85% RH. Subsequently, the image I was printed on 10,000 pieces of paper using the evaluation device in a low-temperature and low-humidity environment of a temperature of 10° C. and a relative humidity of 15% RH. After the printing in the low-temperature and low-humidity environment, the evaluation device was allowed to stand for 2 hours. Subsequently, a solid image (image width image density of 100%) was printed one sheet of paper using the evaluation device in a low-temperature and low-humidity environment. After that, a film thickness T2 of the photosensitive layer of the photoreceptor was measured. Then, the friction amount (T1−T2, unit: μm) that was a film thickness change amount of the photosensitive layer before and after the printing was obtained. The measured friction amount is shown in Table 3 to Table 4. The criteria for judging the wear resistance of the photoreceptor are shown below.

### (Criteria for Wear Resistance)

Good: the friction amount is less than 0.5 μm.

Poor: the friction amount is 0.5 μm or more.

### <Image Deletion>

As an evaluation device of image deletion of the stacked photoreceptor, a modified machine obtained by modifying the charge polarity of a color multifunction device (“Taskalfa 356ci” manufactured by KYOCERA Document Solutions Inc.) to negative charge polarity was used. This evaluation device was equipped with a charging roller including an epichlorohydrin resin in which conductive carbon was dispersed. The development container and the toner cartridge of the evaluation device were filled with a cyan developer and a cyan toner. The photoreceptor was mounted on the evaluation device. The image G1 (pattern image with image density of 1.6%) was printed on one sheet of paper using the evaluation device in a high-temperature and high-humidity environment of a temperature of 32° C. and a relative humidity of 80% RH. Dots forming the printed image G1 were observed using a microscope. Then, whether or not image deletion was suppressed was evaluated in accordance with the following criteria. The evaluation results of image deletion are shown in Table 3 to Table 4.

### (Criteria for Image Deletion Suppression)

Particularly good (A): all dots that should appear in the microscope's field of view are printed.

Good (B): some dots of all dots that should appear in the microscope's field of view have disappeared, and the number of disappeared dots is less than half.

Poor (C): some dots of all dots that should appear in the microscope's field of view have disappeared, and the number of disappeared dots is equal to or more than half.

TABLE 3

| | Stacked | Sensitivity | Charging | Wear | |
|---|---|---|---|---|---|
| | photo- | characteristics | characteristics | amount | Image |
| | receptor | VL [−V] | V0 [−V] | [μm] | deletion |
| Ex 1 | P-A1 | 88 | 572 | 0.2 | A |
| Ex 2 | P-A2 | 126 | 723 | 0.3 | A |
| Ex 3 | P-A3 | 98 | 664 | 0.2 | A |
| Ex 4 | P-A4 | 70 | 589 | 0.2 | A |
| Ex 5 | P-A5 | 52 | 519 | 0.1 | A |
| Ex 6 | P-A6 | 92 | 604 | 0.1 | A |
| Ex 7 | P-A7 | 95 | 580 | 0.2 | A |
| Ex 8 | P-A8 | 81 | 555 | 0.2 | A |
| Ex 9 | P-A9 | 141 | 732 | 0.3 | A |
| Ex 10 | P-A10 | 65 | 535 | 0.1 | A |
| Ex 11 | P-A11 | 135 | 730 | 0.4 | A |
| Ex 12 | P-A12 | 56 | 521 | 0.1 | A |
| Ex 13 | P-A13 | 144 | 745 | 0.3 | A |
| Ex 14 | P-A14 | 68 | 545 | 0.1 | A |
| Ex 15 | P-A15 | 141 | 604 | 0.1 | B |
| Ex 16 | P-A16 | 66 | 487 | 0.1 | B |
| Ex 17 | P-A17 | 89 | 492 | 0.1 | B |
| Ex 18 | P-A18 | 141 | 604 | 0.1 | B |
| Ex 19 | P-A19 | 66 | 487 | 0.1 | B |
| Ex 20 | P-A20 | 89 | 492 | 0.1 | B |

TABLE 4

| | Stacked | Sensitivity | Charging | Wear | |
|---|---|---|---|---|---|
| | photo- | characteristics | characteristics | amount | Image |
| | receptor | VL [−V] | V0 [−V] | [μm] | deletion |
| Comp 1 | P-B1 | 158 | 674 | 0.2 | C |
| Comp 2 | P-B2 | 157 | 710 | 0.5 | C |
| Comp 3 | P-B3 | 291 | 887 | 0.3 | C |
| Comp 4 | P-B4 | 206 | 821 | 0.2 | C |
| Comp 5 | P-B5 | 154 | 680 | 0.1 | C |
| Comp 6 | P-B6 | 49 | 427 | 0.1 | A |
| Comp 7 | P-B7 | 152 | 671 | 0.2 | C |
| Comp 8 | P-B8 | 188 | 714 | 0.2 | C |
| Comp 9 | P-B9 | 73 | 418 | 0.2 | B |
| Comp 10 | P-B10 | 80 | 445 | 0.2 | B |
| Comp 11 | P-B11 | 43 | 733 | 4.6 | A |

In Table 3 to Table 4, “Ex” and “Comp” are synonymous with the terms described in the above Table 1 to Table 2.

As shown in Table 2, in the protective layer included in each of the stacked photoreceptors (P-B1), (P-B4), and (P-B5), the content of the tin oxide particle was not greater than the content of the alumina particle. As shown in Table 4, the sensitivity characteristics and the image deletion of each of the stacked photoreceptors (P-B1), (P-B4), and (P-B5) were evaluated as poor.

As shown in Table 2, the protective layer included in the stacked photoreceptor (P-B2) did not include a tin oxide particle and an alumina particle. As shown in Table 4, the sensitivity characteristics, wear resistance, and image deletion of the stacked photoreceptor (P-B2) were evaluated as poor.

As shown in Table 2, the protective layer included in the stacked photoreceptor (P-B3) did not include a tin oxide particle. As shown in Table 4, the sensitivity characteristics and image deletion of the stacked photoreceptor (P-B3) were evaluated as poor.

As shown in Table 2, the protective layer included in the stacked photoreceptor (P-B6) did not include an alumina particle. As shown in Table 4, the charging characteristics of the stacked photoreceptor (P-B6) were evaluated as poor.

As shown in Table 2, the protective layers included in the stacked photoreceptors (P-B7) and (P-B8) respectively included the first particles (S-5) and (S-6), but the first particles (S-5) and (S-6) were not tin oxide particles. As shown in Table 4, the sensitivity characteristics and image deletion of each of the stacked photoreceptors (P-B7) and (P-B8) were evaluated as poor.

As shown in Table 2, the protective layers included in the stacked photoreceptors (P-B9) and (P-B10) respectively included the second particles (A-2) and (A-3), but the second particles (A-2) and (A-3) were not alumina particles. As shown in Table 4, the charging characteristics of each of the stacked photoreceptors (P-B9) and (P-B10) were evaluated as poor.

As shown in Table 2, the stacked photoreceptor (P-B11) did not include a protective layer. As shown in Table 4, the wear resistance of the stacked photoreceptor (P-B11) was evaluated as poor.

As shown in Table 1, each of the stacked photoreceptors (P-A1) to (P-A20) included a protective layer and the protective layer included a tin oxide particle and an alumina particle. The content of the tin oxide particle was greater than the content of the alumina particle. As shown in Table 3, the sensitivity characteristics, charging characteristics, and image deletion of each of the stacked photoreceptors (P-A1) to (P-A20) were good or particularly good.

### [Production of Single-Layer Photoreceptor]

A single-layer photoreceptor (P-C1) was produced by the following method. The configuration of the protective layer of this single-layer photoreceptor is shown in Table 5.

TABLE 5

| | | Protective layer | | | | | |
|---|---|---|---|---|---|---|---|
| | Single- | | | | | | Total |
| | layer | First particle | | Second particle | | | content |
| | photo- | | Amount | | Amount | First/ | ratio |
| | receptor | Type | [parts] | Type | [parts] | second | [mass %] |
| Ex 21 | P-C1 | S-1 | 8 | A-1 | 5 | 1.6 | 11.5 |

In Table 5, “Ex”, “parts”, “first/second”, and “total content ratio” in the column of the protective layer are synonymous with the terms described in the above Table 1 to Table 2.

### <Production of Single-Layer Photoreceptor (P-C1)>

### (Formation of Single-Layer Photosensitive Layer)

2.85 parts by mass of a Y-type titanyl phthalocyanine, a total of 80 parts by mass of a hole transporting agent (more specifically, 40 parts by mass of a hole transporting agent (HT-2) and 40 parts by mass of a hole transporting agent (HT-3)), a total of 68 parts by mass of an electron transporting agent (more specifically, 34 parts by mass of an electron transporting agent (ET-1) and 34 parts by mass of an electron transporting agent (ET-6)), 70 parts by mass of a bisphenol Z-type polycarbonate resin, 0.02 parts by mass of a leveling agent, and 500 parts by mass of tetrahydrofuran were mixed using a rod-shaped sonic oscillator for 20 minutes to obtain a mixed solution b. As a leveling agent, dimethylsilicone oil (“KF96−50CS” manufactured by Shin-Etsu Chemical Co., Ltd.) was used. The obtained mixed solution b was filtered with a filter with an opening of 5 μm to obtain a coating liquid for a single-layer photosensitive layer. Subsequently, the coating liquid for a single-layer photosensitive layer was applied onto the conductive substrate by a dip coating method. As the conductive substrate, a drum-shaped support formed of aluminum was used. The applied coating liquid for a single-layer photosensitive layer was dried at 110° C. for 60 minutes to form a single-layer photosensitive layer (film thickness: 25 μm) on the conductive substrate. The content ratio of the hole transporting agent was 36.2 mass % (=100×80/(2.85+80+68+70+0.02)) with respect to the mass of the single-layer photosensitive layer. The total content ratio of the hole transporting agent and the electron transporting agent was 67.0 mass % (=100×(80+68)/(2.85+80+68+70+0.02)) with respect to the mass of the single-layer photosensitive layer.

### (Formation of Protective Layer)

The protective layer of the single-layer photoreceptor (P-C1) was formed in the same manner as in the formation of the protective layer of the stacked photoreceptor (P-A1) except that a coating liquid for a protective layer was applied onto the single-layer photosensitive layer instead of onto the charge transporting layer.

### [Evaluation of Single-Layer Photoreceptor]

The sensitivity characteristics, charging characteristics, wear resistance, and image deletion of the single-layer photoreceptor (P-C1) were evaluated by the following method.

### <Sensitivity Characteristics>

The sensitivity characteristics of the single-layer photoreceptor were evaluated in the same manner as in the evaluation of sensitivity characteristics of the stacked photoreceptor except that the surface of the photoreceptor was charged to +550 V instead of −550 V. The measured post-exposure potential VL (unit: +V) is shown in Table 6.

### <Charging Characteristics>

The charging characteristics of the single-layer photoreceptor were evaluated in the same manner as in the evaluation of charging characteristics of the stacked photoreceptor except that the flowing current Ipc from the corotron charger to the photoreceptor from −5 μA to +5 μA. The measured charging potential V0 (unit: +V) is shown in Table 6.

### <Wear Resistance>

The wear resistance of the single-layer photoreceptor was evaluated in the same manner as in the evaluation of wear resistance of the stacked photoreceptor except that the evaluation device was changed from the color printer (“C711dn” manufactured by Oki Electric Industry Co., Ltd.) to a color multifunction device (“Taskalfa 356ci” manufactured by KYOCERA Document Solutions Inc.). The measured friction amount is shown in Table 6.

### <Image Deletion>

The image deletion of the single-layer photoreceptor was evaluated in the same manner as in the evaluation of image deletion of the stacked photoreceptor except that the charge polarity of the evaluation device was returned from the negative charge polarity to the positive charge polarity. The evaluation results of image deletion are shown in Table 6.

TABLE 6

| | Single-layer | Sensitivity | Charging | Wear | |
|---|---|---|---|---|---|
| | photo- | characteristics | characteristics | amount | Image |
| | receptor | VL [+V] | V0 [+V] | [μm] | deletion |
| Ex 21 | P-C1 | 113 | 561 | 0.2 | A |

In Table 6, “Ex” is synonymous with the term described in the above Table 1 to Table 2.

As shown in Table 5, the single-layer photoreceptor (P-C1) included a protective layer and the protective layer included a tin oxide particle and an alumina particle. The content of the tin oxide particle was greater than the content of the alumina particle. As shown in Table 6, the sensitivity characteristics, charging characteristics, wear resistance, and image deletion of the single-layer photoreceptor (P-C1) were good or particularly good.

From the above, it has been shown that the photoreceptor according to the embodiment of the present disclosure, which includes the stacked photoreceptors (P-A1) to (P-A20) and the single-layer photoreceptor (P-C1), have excellent sensitivity characteristics, charging characteristics, and wear resistance and are capable of suppressing the occurrence of image deletion of a formed image. Further, the process cartridge and the image forming apparatus according to the embodiments of the present disclosure include such a photoreceptor, and thus, it can be judged that they have excellent sensitivity characteristics, charging characteristics, and wear resistance of the photoreceptor and are capable of suppressing the occurrence of image deletion of a formed image.

It should be understood by those skilled in the art that various modifications, combinations, sub-combinations and alterations may occur depending on design requirements and other factors insofar as they are within the scope of the appended claims or the equivalents thereof.

What is claimed is:

1. An electrophotographic photoreceptor, comprising:
a conductive substrate;
a photosensitive layer; and
a protective layer,
the photosensitive layer including a charge generating agent and a hole transporting agent,
the protective layer being a top surface layer of the electrophotographic photoreceptor,
the protective layer including a tin oxide particle and an alumina particle,
a content of the tin oxide particle being greater than a content of the alumina particle.

2. The electrophotographic photoreceptor according to claim 1, wherein
the tin oxide particle is a phosphorus-doped tin oxide particle or an antimony-doped tin oxide particle.

3. The electrophotographic photoreceptor according to claim 1, wherein
a total content ratio of the tin oxide particle and the alumina particle is 0.1 mass % or more and 13.0 mass % or less with respect to a mass of the protective layer.

4. The electrophotographic photoreceptor according to claim 1, wherein
a ratio of the content of the tin oxide particle to the content of the alumina particle is 1.1 or more and 15.0 or less.

5. The electrophotographic photoreceptor according to claim 1, wherein
the protective layer further includes a photocurable resin, and
the photocurable resin includes a repeating unit derived from a compound having one polymerizable functional group and a repeating unit derived from a compound having two or more polymerizable functional groups.

6. The electrophotographic photoreceptor according to claim 5, wherein
the repeating unit derived from a compound having one polymerizable functional group has a water-repellent group, and
the repeating unit derived from a compound having two or more polymerizable functional groups does not have the water-repellent group.

7. The electrophotographic photoreceptor according to claim 5, wherein
the repeating unit derived from a compound having one polymerizable functional group is a repeating unit derived from the compound represented by the following formula (EB-1): 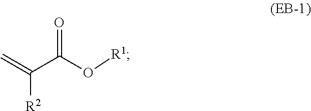
wherein, in the formula (EB-1), R¹ represents a group represented by a formula (b1) and R² represents a hydrogen atom or a methyl group; 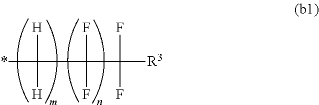
wherein, in the formula (b1), m represents 0 or 1, n represents an integer of 1 or more and 3 or less, R³ represents a hydrogen atom or a fluorine atom, and * represents atomic bonding.

8. The electrophotographic photoreceptor according to claim 5, wherein
the repeating unit derived from a compound having two or more polymerizable functional groups is a repeating unit derived from at least one selected from the group consisting of compounds represented by formulae (EA-3) and (EA-4):

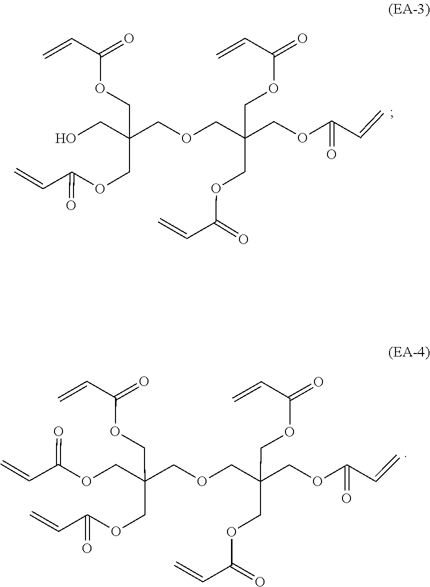

9. The electrophotographic photoreceptor according to claim 1, wherein
the protective layer has a thickness of 1 μm or more and 4 μm or less.

10. The electrophotographic photoreceptor according to claim 1, wherein
the charge generating agent included in the photosensitive layer contains titanyl phthalocyanine.

11. The electrophotographic photoreceptor according to claim 1, wherein
the photosensitive layer includes a charge generating layer and a charge transporting layer,
the charge generating layer includes the charge generating agent,
the charge transporting layer includes the hole transporting agent,
a content ratio of the hole transporting agent is 40.0 mass % or more with respect to a mass of the charge transporting layer.

12. A process cartridge, comprising:
at least one selected from the group consisting of a charging device, an exposure device, a development device, a transfer device, a cleaning member, a rubbing roller, and a static elimination device; and
the electrophotographic photoreceptor according to claim 1.

13. An image forming apparatus, comprising:
an image carrier;
a charging device that charges a surface of the image carrier;
an exposure device that exposes the charged surface of the image carrier to form an electrostatic latent image on the surface of the image carrier;
a development device that supplies a toner to the surface of the image carrier to develop the electrostatic latent image as a toner image; and
a transfer device that transfers the toner image from the image carrier onto a to-be-transferred body,
the image carrier being the electrophotographic photoreceptor according to claim 1.

14. The image forming apparatus according to claim 13, further comprising
at least one selected from the group consisting of
a cleaning member that collects the toner adhering to the surface of the image carrier,
a rubbing roller that rubs the surface of the image carrier, and
a static elimination device that eliminates static electricity on the surface of the image carrier.

15. The image forming apparatus according to claim 13, wherein
the charging device is a charging roller.

16. The image forming apparatus according to claim 13, wherein
the development device supplies the toner charged due to friction with a carrier to the surface of the image carrier.
